(19) United States
(12) Patent Application Publication
(10) Pub. No.: US 2022/0219699 A1
(43) Pub. Date: Jul. 14, 2022

(54) ON-BOARD APPARATUS, DRIVING ASSISTANCE METHOD, AND DRIVING ASSISTANCE SYSTEM

(71) Applicant: Faurecia Clarion Electronics Co., Ltd.,, Saitama-shi, Saitama (JP)

(72) Inventors: Norikazu NARA, Saitama (JP); Tetsuro MURAKAMI, Saitama (JP); Naoto SAKATA, Saitama (JP)

(73) Assignee: Faurecia Clarion Electronics Co., Ltd.,, Saitama-shi, Saitama (JP)

(21) Appl. No.: 17/615,349

(22) PCT Filed: May 29, 2020
(86) PCT No.: PCT/JP2020/021274

§ 371 Date: Nov. 30, 2021

(30) Foreign Application Priority Data
May 30, 2019 (JP) 2019-101582

(51) Int. Cl. B60W 30/18; G01C 21/36; G06V 20/58

(52) U.S. Cl. CPC B60W 30/18154; G01C 21/36; B60W 2555/60; B60W 2420/42; B60W 2552/05; G06V 20/584

(57) ABSTRACT

A possibility that driving assistance suitable for a road environment will be not provided is reduced. An on-board apparatus, which navigates a vehicle based on the map information including information indicating a road network including a plurality of links respectively corresponding to a plurality of roads and a plurality of nodes respectively corresponding to a plurality of intersections and information indicating road attributes in the road network, includes an image capturing unit and a support control unit. The image capturing unit captures an image of at least a part around the vehicle. The support control unit associates supplementary information, which is information including recognition result information indicating a result of image recognition of the captured image, with link information of a target link, which is a link corresponding to a point related to the image capturing of the image.

### TECHNICAL FIELD

The present invention generally relates to a technique for assisting driving of a vehicle.

### BACKGROUND ART

In recent years, in the car navigation (hereinafter referred to as “NAVI”) industry, standard interface specifications have been established to provide various NAVI data, such as digital map data and position data, to an ADAS (Advanced Driver Assistance System) unit, and new functions utilizing NAVI data have been actively developed. As an example of such new functions, there is known a function to assist driving related to an intersection with poor visibility.

It is disclosed that whether or not a road has poor visibility is determined from GPS (Global Positioning System) positioning results, road types in map data for a nearby area in the traveling direction, road widths, connection angles of multiple road links, number of intersections, curvature of curves, elevation data, travel trajectories, and the like (see PTL 1).

### CITATION LIST

### Patent Literature

[PTL 1] WO 2004/064007

### SUMMARY OF INVENTION

### Technical Problem

PTL 1 discloses a method for determining whether or not a road has poor visibility from map information, but fails to disclose or suggest a method for determining whether or not an intersection has poor visibility.

Accordingly, it is conceivable that such a method is provided which determines whether or not an intersection has poor visibility from map information.

However, the map information does not necessarily provide the current road environment. In other words, there may be a situation where the map information needs to be updated. Further, the map information does not always provide the road environment at the site in detail. For these reasons, the accuracy of determining whether or not an intersection has poor visibility is not always high.

Thus, driving assistance suitable for the road environment may not be performed. For example, there may be at least one of a case where driving assistance for an intersection with poor visibility is not provided in spite of being an intersection with poor visibility, and a case where driving assistance for an intersection with poor visibility is provided in spite of being a normal intersection (an intersection other than an intersection with poor visibility).

The problems as described above may also occur at a point other than an intersection with poor visibility.

The present invention has been made in consideration of the foregoing, and an object of the present invention is to reduce a possibility that driving assistance suitable for a road environment will not be provided.

### Solution to Problem

In order to solve such problems, an on-board apparatus captures an image of at least a part around a vehicle, and associates event information that is information including recognition result information indicating a result of image recognition of the captured image with link information of a link corresponding to a point related to the image capturing of the image.

### Advantageous Effects of Invention

According to the present invention, it is possible to reduce the possibility that driving assistance suitable for the road environment is not provided.

### BRIEF DESCRIPTION OF DRAWINGS

FIG. 1 is a diagram illustrating an example of a configuration of a driving information providing system according to a first embodiment.

FIG. 2 is a diagram illustrating an example of a configuration of an on-board apparatus.

FIG. 3 is a diagram illustrating an example of a configuration of a server apparatus.

FIG. 4 is a diagram illustrating an example of functions of the on-board apparatus.

FIG. 5 is a diagram illustrating an example of functions of the server apparatus.

FIG. 6 is a diagram illustrating an example of a personal event table included in user information.

FIG. 7 illustrates an example of a flowchart related to processing performed by the on-board apparatus.

FIG. 8 illustrates an example of a flowchart related to processing performed by the on-board apparatus.

FIG. 9 is a diagram for explaining an approximate remaining distance.

FIG. 10 illustrates an example of a flowchart related to processing performed by the on-board apparatus.

FIG. 11 illustrates an example of a flowchart related to processing performed by the server apparatus.

FIG. 12 is a diagram for explaining a stop position.

FIG. 13 illustrates an example of a flowchart related to processing performed by the on-board apparatus.

FIG. 14 is a diagram for explaining an exact remaining distance.

FIG. 15 illustrates an example of a flowchart related to processing performed by the on-board apparatus.

FIG. 16 illustrates an example of a flowchart related to processing performed by the server apparatus.

FIG. 17 illustrates an example of a flowchart related to processing performed by the on-board apparatus.

FIG. 18 is a diagram for explaining trajectory information.

FIG. 19 illustrates an example of a flowchart related to processing performed by the on-board apparatus.

FIG. 20 illustrates an example of a flowchart related to processing performed by the on-board apparatus.

FIG. 21 is a diagram for explaining determination of leaving.

FIG. 22 is a diagram illustrating an example of a configuration of a driving assistance system according to a second embodiment.

FIG. 23 is a diagram illustrating an example of functions of an on-board apparatus.

FIG. 24 is a diagram illustrating an example of functions of a management server apparatus.

FIG. 25 is a diagram illustrating an example of functions of an object detection server apparatus.

FIG. 26 is a diagram for explaining an outline of the second embodiment.

FIG. 27 illustrates an example of a flowchart related to a series of steps of processing related to updating of event information in a server apparatus.

FIG. 28 illustrates an example of a flowchart related to a series of steps of processing related to updating of event information in the on-board apparatus.

FIG. 29 is a diagram illustrating an example of an event file.

FIG. 30 is a diagram illustrating an example of a personal event table in the management server apparatus.

FIG. 31 illustrates an example of a flowchart related to intersection determination processing.

FIG. 32 illustrates an example of a reliability determination policy.

FIG. 33 illustrates an example of a flowchart related to processing including image capturing timing adjustment processing.

### DESCRIPTION OF EMBODIMENTS

Various embodiments of the present invention will be described below in detail with reference to drawings.

### (1) First Embodiment

The present embodiment relates to a technique for providing driving assistance for an intersection at an appropriate timing. For example, in a driving information providing system according to the present embodiment, driving assistance is performed when a vehicle approaches an intersection, when a vehicle enters an intersection, when a vehicle leaves an intersection, and the like. As a result, driving related to the intersection is assisted. The “driving assistance” may be to control a vehicle (specifically, e.g., a component (e.g., an accelerator, a brake, a steering wheel, etc.)) in a traveling system of the vehicle, may be to notify information related to an intersection (e.g., a stop position related to an intersection, a trajectory in an intersection, leaving an intersection) (e.g., informing a driver, a pedestrian, another vehicle, or the like), or may be other assistance. The “driving related to an intersection” refers to driving at least one of the intersection and the vicinity of the intersection, specifically, at least one of driving when the vehicle approaches the intersection, driving when the vehicle enters the intersection, and driving when the vehicle leaves the intersection.

It is noted that, when the following description is given without discriminating elements of the same type from each other, the common portions (exclusive of branch numbers) of reference signs including branch numbers may be used while, when the following description is given while discriminating elements of the same type from each other, the reference signs including branch numbers may be used. For example, when a camera is described without specific discrimination, it may be described as the “camera 113”, and when each individual camera is described with discrimination, it may be described as the “front camera 113-1” and the “rear camera 113-2”.

Further, in the following description, for simplicity of description, a user and a vehicle have a one-to-one relation. However, actually, one user may use two or more vehicles, or a plurality of users may use the same vehicle. Accordingly, in the following description, user-specific information may be at least partly replaced with vehicle-specific information.

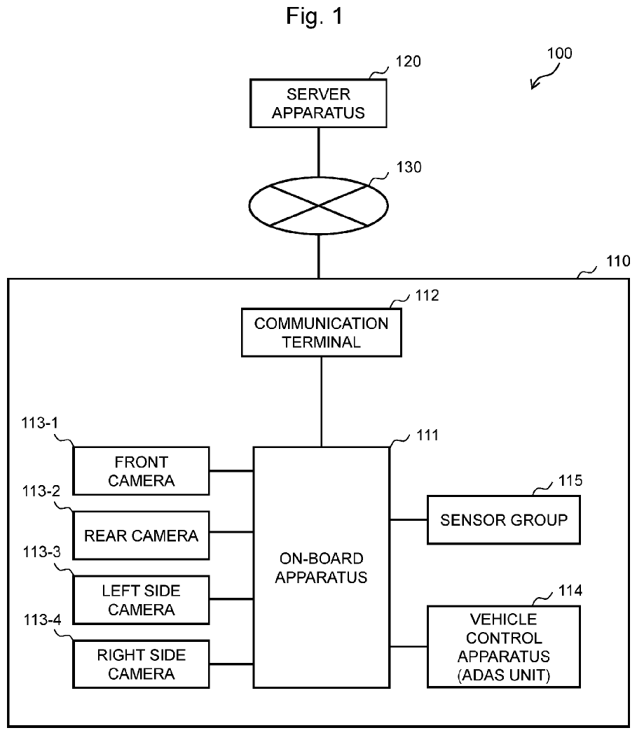

FIG. 1 is a diagram illustrating an example of a configuration of a driving information providing system 100.

The driving information providing system 100 provides various information to a user riding in a vehicle 110 and controls driving of the vehicle 110 according to the travel state of the vehicle 110. In the driving information providing system 100, the vehicle 110 and a server apparatus 120 are connected to each other via a communication line network 130.

The vehicle 110 includes an on-board apparatus 111, a communication terminal 112, cameras 113, a vehicle control apparatus 114, and a sensor group 115. The on-board apparatus 111 and the communication terminal 112 are connected to each other by wire or wirelessly.

The on-board apparatus 111 provides various information to the user (e.g., the driver) of the vehicle 110 according to the travel state of the vehicle 110. To the on-board apparatus 111, the communication terminal 112 that communicates with the server apparatus 120, the cameras 113 that each capture an image in accordance with an instruction from the on-board apparatus 111 (or an apparatus different from the on-board apparatus 111), and the vehicle control apparatus 114 that performs various steps of processing and controls related to the travel of the vehicle 110 are connected.

The communication terminal 112 makes a wireless connection with the communication line network 130 as needed under the control of the on-board apparatus 111. To the communication line network 130, the server apparatus 120 is connected. Accordingly, the on-board apparatus 111 can communicate with the server apparatus 120 by connecting to the server apparatus 120 via the communication terminal 112 and the communication line network 130. When the communication terminal 112 and the communication line network 130 are wirelessly connected to each other, a wireless base station (not illustrated) of the communication line network 130 is used. The wireless base station can wirelessly communicate with the communication terminal 112 located in a predetermined communication area around the wireless base station, and such wireless base stations are installed in various places. It is noted that the communication terminal 112 is, for example, a mobile phone or the like.

As the cameras 113, the vehicle 110 includes, for example, a front camera 113-1 mounted and directed to the front of the vehicle 110, a rear camera 113-2 mounted and directed to the rear of the vehicle 110, a left side camera 113-3 mounted and directed to the left side of the vehicle 110, and a right side camera 113-4 mounted and directed to the right side of the vehicle 110. One or some of these cameras 113 may not be provided, or another camera 113 may be provided instead of or in addition to one or some of the cameras 113.

The vehicle control apparatus 114 is composed of one or more ECUs (Electronic Control Units). Various types of ECUs are mounted on the vehicle 110 depending on the functions of the vehicle control apparatus 114, the control target, and the like. The one or more ECUs include one or more ADAS units. The ADAS unit is an example of an advanced driver assistance system (ADAS) or an element thereof, and controls a driving operation, alerts a user, and supports comfortable driving, for example.

The sensor group 115 is made up of one or more sensors mounted on the vehicle 110, including, for example, a gyro sensor, a vehicle speed sensor, and the like. One or some of the sensors in the sensor group 115 may be provided in the on-board apparatus 111 instead of or in addition to the vehicle 110.

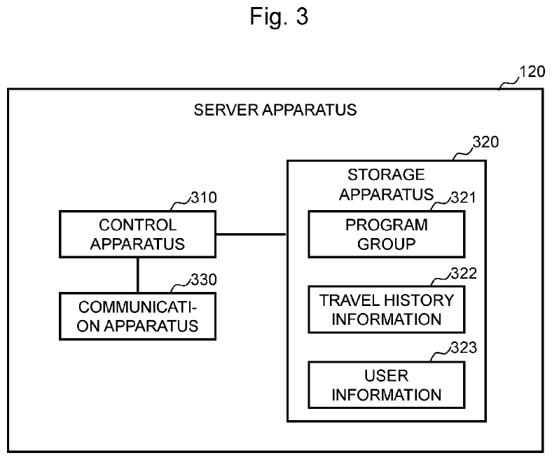

The server apparatus 120 stores travel history information 322, user information 323, and the like (see FIG. 3), which will be described below. By downloading and acquiring such information from the server apparatus 120, the on-board apparatus 111 can estimate a travel route of the vehicle 110 and provide information to the user.

For example, when the server apparatus 120 receives a delivery request for stop information to be transmitted from the on-board apparatus 111 via the communication terminal 112 and the communication line network 130, the server apparatus 120 extracts the stop information corresponding to the delivery request from the user information 323, and delivers the stop information to the on-board apparatus 111. The stop information includes position information indicating the position of the vehicle 110 when the vehicle 110 stops with respect to the intersection, and azimuth information indicating the azimuth of the vehicle 110 when the vehicle 110 stops with respect to the intersection. The on-board apparatus 111 can transmit the stop information received from the server apparatus 120 to the ADAS unit, and provide the user with the stope information by means of screen display, audio output, and the like.

The communication line network 130 is constructed by, for example, a mobile phone network, the Internet, or the like.

It is noted that, although FIG. 1 illustrates an example in which one on-board apparatus 111 mounted on one vehicle 110 is connected to the server apparatus 120, in practice, on-board apparatuses mounted on a large number of vehicles are each connected to the server apparatus 120, and the on-board apparatuses provide information to the respective users. In the present embodiment, the operation of the onboard apparatus 111 which is one of the on-board apparatuses will be described as a representative example, but the same applies to the other on-board apparatuses.

However, the configuration of the driving information providing system 100 is not limited to the configuration described above. For example, the server apparatus 120 may not be provided. In this case, the on-board apparatus 111 includes all or a part of the configuration of the server apparatus 120.

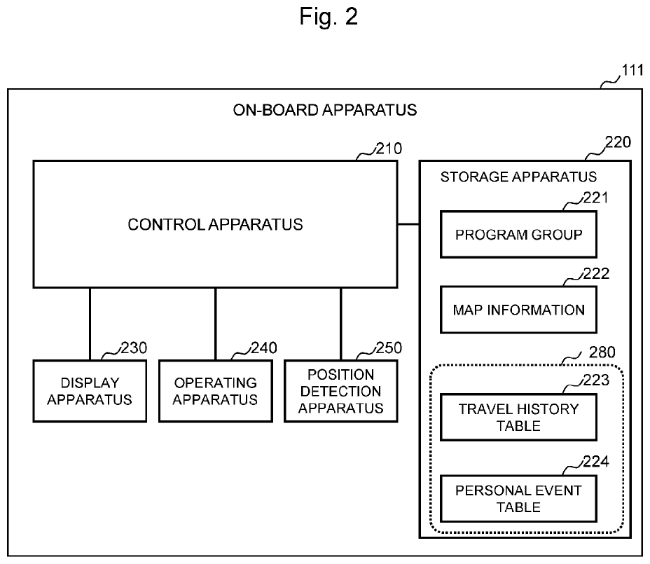

FIG. 2 is a diagram illustrating an example of a configuration of the on-board apparatus 111.

The on-board apparatus 111 includes a control apparatus 210, a storage apparatus 220, a display apparatus 230, an operating apparatus 240, and a position detection apparatus 250.

The control apparatus 210 includes a CPU (Central Processing Unit) (not illustrated) and the like, and performs various steps of processing and operations for operating the on-board apparatus 111.

The storage apparatus 220 includes at least one of a ROM (Read Only Memory), a RAM (Random Access Memory), an HDD (Hard Disk Drive), an SSD (Solid State Drive), a memory card, and the like. The storage apparatus 220 stores various types of information.

For example, the storage apparatus 220 stores part or all of a program group 221 (one or more programs) to be executed by the control apparatus 210.

Further, for example, the storage apparatus 220 stores map information 222 including various information related to a map (e.g., information such as road positions, junctions, shapes, widths, and the number of lanes, and information such as terrains, city names, and region names). Specifically, the map information 222 includes information indicating a road network including a plurality of links respectively corresponding to a plurality of roads and a plurality of nodes respectively corresponding to a plurality of intersections, and information indicating road attributes in the road network. In other words, information of a map for displaying a map screen in the onboard apparatus 111 is stored in the storage apparatus 220 as the map information 222. The road network is generally a graph represented by nodes and links, but in the information indicating the road network, each of the nodes and links may be represented by polygons.

Further, for example, the storage apparatus 220 stores individual information 280 for each user separately from the map information 222. The individual information 280 includes, for example, a travel history table 223 indicating a travel history of the vehicle 110 and a personal event table 224 related to an event that has occurred for the user.

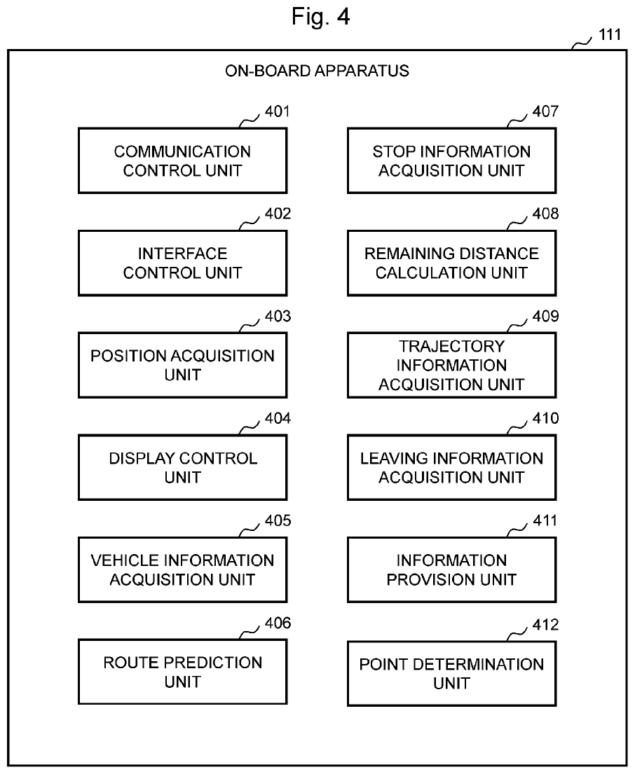

In the on-board apparatus 111, for example, the program group 221 stored in a ROM is loaded into a RAM and executed by the CPU, so that functions of the on-board apparatus 111 (e.g., a communication control unit 401, an interface control unit 402, a position acquisition unit 403, a display control unit 404, a vehicle information acquisition unit 405, a route prediction unit 406, a stop information acquisition unit 407, a remaining distance calculation unit 408, a trajectory information acquisition unit 409, a leaving information acquisition unit 410, an information provision unit 411, and a point determination unit 412, which are illustrated in FIG. 4 and will be described below) can be implemented. It is noted that the functions of the on-board apparatus 111 will be described below in detail.

In other words, the functions of the on-board apparatus 111 may be implemented by, for example, the CPU reading out the program group 221 stored in the ROM into the RAM and executing the program group 221 (software), may be implemented by hardware such as a dedicated circuit or the like, or may be implemented by a combination of software and hardware. Further, one or some of the functions of the onboard apparatus 111 may be implemented by another computer (e.g., the server apparatus 120) capable of communicating with the on-board apparatus 111.

The display apparatus 230 is an example of an output apparatus, and displays various images, videos, and the like under the control of the display control unit 404 described below. The display apparatus 230 is configured using, for example, a liquid crystal display.

The operating apparatus 240 is an example of an input apparatus, receives an operation input from the user, and outputs operation information corresponding to the content of the received operation to the control apparatus 210. The operating apparatus 240 includes, for example, a touch panel integrated with the display apparatus 230, various switches, and the like. Further, the operating apparatus 240 may receive an operation input from the user by voice.

The position detection apparatus 250 detects the current position of the vehicle 110 and outputs the detection result to the control apparatus 210. The position detection apparatus 250 is, for example, a GPS sensor.

FIG. 3 is a diagram illustrating an example of a configuration of the server apparatus 120.

The server apparatus 120 includes a control apparatus 310, a storage apparatus 320, and a communication apparatus 330.

The control apparatus 310 includes a CPU (not illustrated), and performs various steps of processing and operations for operating the server apparatus 120.

The storage apparatus 320 includes at least one of a ROM, a RAM, an HDD, an SSD, a memory card, and the like. The storage apparatus 320 stores various types of information.

For example, the storage apparatus 320 stores part or all of a program group 321 (one or more programs) to be executed by the control apparatus 310.

Further, for example, the storage apparatus 320 stores the travel history information 322 indicating travel histories of a large number of vehicles including the vehicle 110 connected to the server apparatus 120. The travel history information 322 may include, for example, a travel history table for each user.

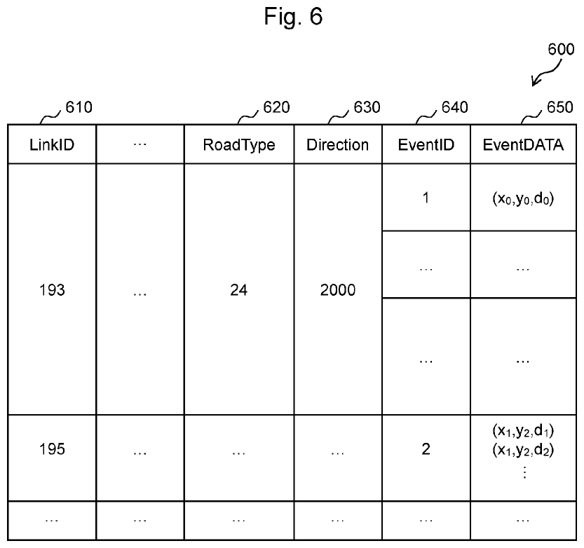

Further, for example, the storage apparatus 320 stores the user information 323 that is information on the user of each on-board apparatus. The user information 323 includes, for example, a personal event table 600 (see FIG. 6) for each user, as described below.

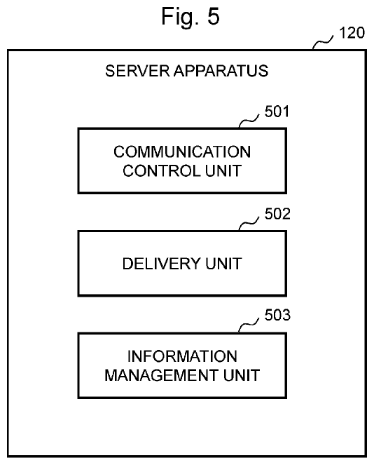

The control apparatus 310 loads the program group 321 stored in the ROM into the RAM and executes the program group 321, so that functions of the server apparatus 120 (e.g., a communication control unit 501, a delivery unit 502, and the information management unit 503, described below and illustrated in FIG. 5) can be implemented. It is noted that the details of these functions implemented by the control apparatus 310 will be described below.

In other words, the functions of the server apparatus 120 may be implemented by, for example, the CPU reading out the program group 321 stored in the ROM into the RAM and executing the program group 321 (software), may be implemented by hardware such as a dedicated circuit or the like, or may be implemented by a combination of software and hardware. Further, one or some of the functions of the server apparatus 120 may be implemented by another computer (e.g., the on-board apparatus 111) capable of communicating with the server apparatus 120.

FIG. 4 is a diagram illustrating an example of the functions of the on-board apparatus 111.

The on-board apparatus 111 includes the communication control unit 401, the interface control unit 402, the position acquisition unit 403, the display control unit 404, the vehicle information acquisition unit 405, the route prediction unit 406, the stop information acquisition unit 407, the remaining distance calculation unit 408, the trajectory information acquisition unit 409, a leaving information acquisition unit 410, the information provision unit 411, and the point determination unit 412.

The communication control unit 401 controls the communication terminal 112 when the on-board apparatus 111 communicates with the server apparatus 120 via the communication terminal 112 and the communication line network 130. The on-board apparatus 111 can transmit and receive information to and from the server apparatus 120 by controlling the communication terminal 112 using the communication control unit 401.

The interface control unit 402 performs interface control when the on-board apparatus 111 communicates with each of the camera 113, the vehicle control apparatus 114, and the sensor group 115. The on-board apparatus 111 communicates with the camera 113, the vehicle control apparatus 114, and the sensor group 115 by the interface control performed by the interface control unit 402, so that the on-board apparatus 111 can acquire a captured image output from the camera 113, instruct the vehicle control apparatus 114 to operate, notify the vehicle control apparatus 114 of information, acquire values from the sensor group 115, and the like.

The position acquisition unit 403 acquires a result of detecting the position of the vehicle 110 from the position detection apparatus 250. Further, the position acquisition unit 403 calculates a traveling direction of the on-board apparatus 111 based on a sensor value of the gyro sensor and calculates a speed of the vehicle 110 based on a sensor value of the vehicle speed sensor, thereby acquiring a position (relative position) relative to a position calculated based on a sensor value of the GPS sensor (an absolute position indicating the position detection result acquired from the position detection apparatus 250). The calculation of the relative position is generally called dead reckoning, and is performed periodically (e.g., every 0.1 seconds).

Here, the position of the vehicle 110 (dead reckoning position) determined based on the relative position in addition to the absolute position is represented by numerical position coordinates with an error, and thus does not completely match the corresponding road position in the map information 222. Accordingly, the position acquisition unit 403 determines which road in the map information 222 the dead reckoning position corresponds to. Such processing is generally called map matching, and is performed periodically (e.g., every 1 second).

In this way, the position acquisition unit 403 acquires the position of the vehicle 110 (map matching position) when the dead reckoning position is put on a road considered to be optimal among the roads on the map stored in the map information 222. It is noted that, even if the dead reckoning position actually acquired as position coordinates is numerically strictly out of a road portion on the map, the map matching makes it possible to obtain a trajectory of the vehicle 110 displayed on the display apparatus 230 as movement almost following the shape of the road on the map.

The display control unit 404 performs a control to cause the display apparatus 230 to display a map screen by using the map information 222 stored in the storage apparatus 220. Further, a control is performed to cause the display apparatus 230 to display, for example, an image indicating the surrounding environment of the vehicle 110 generated based on the stop information acquired from the server apparatus 120, the captured image acquired from the camera 113, and the like. Furthermore, the display control unit 404 urges the user to exercise caution by performing a control to display a screen related to an intersection on the display apparatus 230.

The vehicle information acquisition unit 405 acquires various vehicle information related to a travel state of the vehicle 110. The vehicle information acquired by the vehicle information acquisition unit 405 includes, for example, a captured image output from the camera 113, control information output from the vehicle control apparatus 114, and the like. The vehicle information acquisition unit 405 can acquire such vehicle information via the interface control unit 402.

The route prediction unit 406 predicts a travel route on which the vehicle 110 will travel now based on at least the travel history table 223 of the map information 222 and the travel history table 223. It is noted that, in the travel history table 223, the history of the route on which the vehicle 110 has traveled in the past on a link sequence basis is recorded. By referring to the travel history table 223, the route prediction unit 406 can estimate a destination that the user heads for, and can predict a travel route of the vehicle 110 from the current position to the destination.

The point determination unit 412 determines from the map information 222 whether or not there is an intersection where the vehicle 110 enters a second road from a first road.

The stop information acquisition unit 407 acquires the stop information when the vehicle 110 stops on the first road with respect to the intersection where the vehicle 110 enters the second road from the first road (e.g., information indicating a stop position indicating the position of the vehicle 110 when the vehicle 110 stops with respect to the intersection and a stop azimuth that is the azimuth of the vehicle 110 when the vehicle 110 stops with respect to the intersection). In the present embodiment, a case will be described as an example where the type of the first road is a narrow road and the type of the second road is a wide road. However, the roads are not limited to the combinations of such road types. It is noted that the type of the road may be a type specified in advance, or may be determined by a width of the road and the like.

In other words, in the present embodiment, with respect to intersections where the vehicle 110 enters the second road from the first road, an intersection in which the type of the first road is a narrow road, and the type of the second road is a wide road is presumed to be an intersection with poor visibility, as described below.

The remaining distance calculation unit 408 calculates either an approximate remaining distance that is a distance from the position of the vehicle 110 to an intersection or an exact remaining distance that is a distance from the position of the vehicle 110 to a stop position of the vehicle 110 before entering an intersection. For example, the remaining distance calculation unit 408 calculates such a distance each time the position of the vehicle 110 is updated by dead reckoning.

The trajectory information acquisition unit 409 acquires, as trajectory information, a position of the vehicle 110 after the vehicle 110 stops with respect to an intersection.

The leaving information acquisition unit 410 determines whether or not the vehicle 110 has left the intersection. If determining that the vehicle 110 has left the intersection, the leaving information acquisition unit 410 acquires leaving information indicating that the vehicle 110 has left the intersection.

The information provision unit 411 performs at least one of: providing at least one or some of the stop information acquired by the stop information acquisition unit 407, information indicating the distance calculated by the remaining distance calculation unit 408, the trajectory information acquired by the trajectory information acquisition unit 409, the leaving information acquired by the leaving information acquisition unit 410, and the like to the display apparatus 230 through the display control unit 404; providing the at least one or some of information to the vehicle control apparatus 114 through the interface control unit 402; and providing the at least one or some of information to the server apparatus 120 through the communication control unit 401.

For example, the information provision unit 411 issues an operation instruction to the vehicle control apparatus 114 based on map information around the current position acquired from the map information 222, the vehicle information acquired by the vehicle information acquisition unit 405, and the like, and controls the running state of the vehicle 110. It is noted that the information provision unit 411 can issue an operation instruction to the vehicle control apparatus 114 via the interface control unit 402. Further, the operation of the information provision unit 411 may provide automatic driving of the vehicle 110.

FIG. 5 is a diagram illustrating an example of the functions of the server apparatus 120.

The server apparatus 120 includes the communication control unit 501, the delivery unit 502, and the information management unit 503.

The communication control unit 501 performs communication control required when the server apparatus 120 communicates with the on-hoard apparatus 111 via the communication terminal 112 and the communication line network 130. The communication control unit 501 performs, for example, interface processing between the server apparatus 120 and the communication line network 130 in the communication control.

The delivery unit 502 delivers information recorded in the travel history information 322 and the user information 323 to the on-board apparatus 111 in response to a delivery request from the on-board apparatus 111. For example, when receiving a delivery request for the stop information of the vehicle 110 from the on-board apparatus 111, the delivery unit 502 acquires the stop information of the vehicle 110 corresponding to the user of the vehicle 110 and the position of the vehicle 110 from the user information 323, and delivers it to the on-board apparatus 111. It is noted that, when the delivery unit 502 distributes such information to the on-board apparatus 111, the communication control unit 501 performs a communication between the server apparatus 120 and the on-board apparatus 111.

The information management unit 503 manages information stored in the storage apparatus 320. For example, the information management unit 503 updates the travel history information 322, the user information 323, and the like based on input information from an operator of the server apparatus 120, the user of the vehicle 110, and the like.

For example, the information management unit 503 stores the stop information acquired by the stop information acquisition unit 407 in association with link information of a road related to the intersection (e.g., identification information for identifying a link).

Further, for example, when the latest stop information of the vehicle 110 is transmitted from the on-board apparatus 111, the information management unit 503 updates, in response to this, the already stored stop information of the user information 323. More specifically, if one or more other pieces of stop information for link information have been stored when the information management unit 503 stores the stop information acquired by the stop information acquisition unit 407 in association with the link information, the information management unit 503 performs filtering processing on all the pieces of stop information for the link information to remove noise to calculate a representative value, and then stores the calculated representative value in association with the link information as stop information related to the intersection.

FIG. 6 is a diagram illustrating an example of the personal event table 600 included in the user information 323. The personal event table 600 is provided for each user. In the personal event table 600, various information (event information) related to each person that cannot be supplemented from the map information 222 is managed in association with link information.

The personal event table 600 stores a piece of event information (e.g., EventID 640, EventDATA 650, etc.) for each piece of link information (e g, LinkID 610, RoadType 620, Direction 630, etc.).

The LinkID 610 is identification information for identifying a link for indicating an actually existing road on a map. The RoadType 620 is information indicating the type of a road (narrow road, wide road, etc.). The Direction 630 is information indicating the azimuth of the vehicle 110 at the time of map matching. The EventID 640 is information for identifying the type of an event that has occurred on a road (e.g., acquisition of stop information, acquisition of trajectory information, and the like). The EventDATA 650 is data such as the position of the vehicle 110 when the vehicle 110 stops with respect to an intersection with poor visibility (stop position), the azimuth of the vehicle 110 when the vehicle 110 stops with respect to the intersection with poor visibility (stop azimuth), the route on which the vehicle 110 has traveled with respect to the intersection with poor visibility (trajectory), the position at which the vehicle 110 left the intersection with poor visibility (exit position), the operation history of the operating apparatus 240, the mode of the vehicle 110, the route on which the vehicle 110 has traveled, and the like.

Next, operations of the on-hoard apparatus 111 and the server apparatus 120 when driving assistance for an intersection is provided will be described.

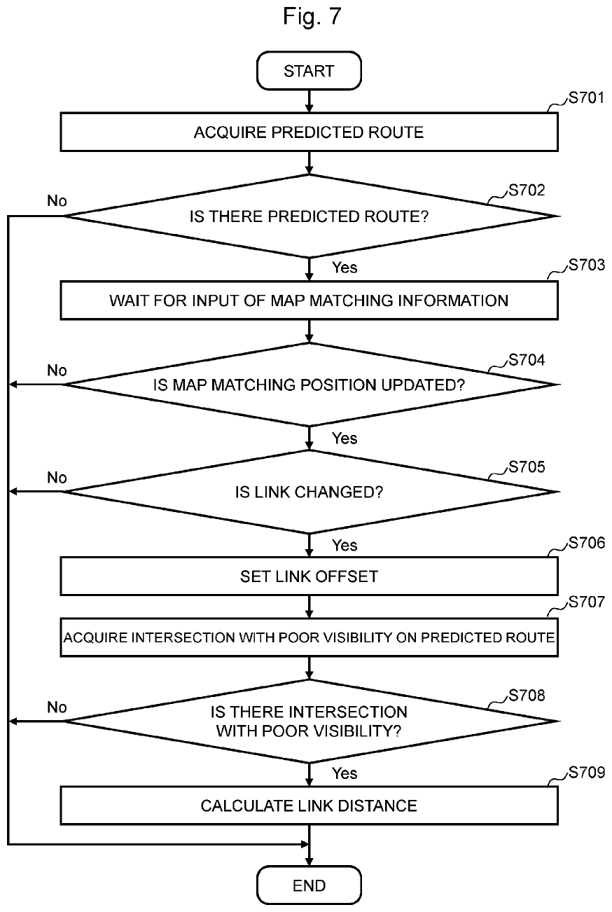

FIG. 7 illustrates an example of a flowchart related to processing of calculating a link distance that is a distance from a starting point node of a link of a road on which the vehicle 110 is traveling to an intersection with poor visibility. The control apparatus 210 of the on-board apparatus 111 executes, for example, the processing illustrated in FIG. 7 at a predetermined processing cycle.

In step S701, the on-board apparatus 111 acquires a predicted route. For example, the on-board apparatus 111 acquires links from the current location (the current position of the vehicle 110) to a destination (a position that the vehicle 110 is to head for) from the map information 222. It is noted that the predicted route may be a route predicted without inputting a destination.

In step S702, the on-board apparatus 111 determines whether or not links have been acquired (whether or not there is a predicted route). If the on-board apparatus 111 determines that there is a predicted route, the processing proceeds to step S703. If the onboard apparatus 111 determines that there is no predicted route, the processing ends.

In step S703, the on-board apparatus 111 waits for input of map matching information. For example, the on-board apparatus 111 stands by until the calculation of the map matching position is completed.

In step S704, the on-hoard apparatus 111 determines whether or not the map matching position has been updated. If the on-board apparatus 111 determines that the map matching position has been updated, the processing proceeds to step S705. If the on-board apparatus 111 determines that the map matching position has not been updated, the processing ends.

In step S705, the on-board apparatus 111 determines whether or not the links have been changed. If the on-board apparatus 111 determines that the links have been changed, the processing proceeds to step S706. If the on-board apparatus 111 determines that the links have not been changed, the processing ends.

In step S706, the on-board apparatus 111 sets a link offset. For example, the onboard apparatus 111 sets the starting point node of a map-matched link as the link offset.

In step S707, the on-board apparatus 111 acquires an intersection with a poor visibility on the predicted route. More specifically, the on-board apparatus 111 specifies, as an intersection with poor visibility on the predicted route, a node (intersection node) whose road type changes from the narrow road to the wide road based on the map information 222, and acquires all links forming a pair (a narrow road link and a wide road link).

In step S708, the on-board apparatus 111 determines whether or not an intersection with poor visibility has been acquired (whether or not there is an intersection with poor visibility). If the on-board apparatus 111 determines that there is an intersection with poor visibility, the processing proceeds to step S709. If the on-board apparatus 111 determines that there is no intersection with poor visibility, the processing ends.

In step S709, the on-board apparatus 111 calculates a distance from the link offset to the intersection node (link distance).

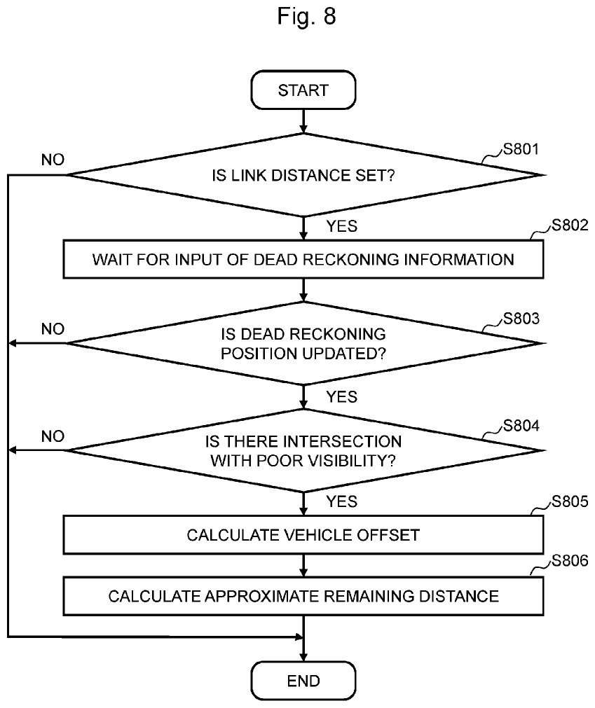

FIG. 8 illustrates an example of a flowchart related to processing of calculating an approximate remaining distance that is an approximate distance from the current position of the vehicle 110 to an intersection with poor visibility. The control apparatus 210 of the on-board apparatus 111 executes, for example, the processing illustrated in FIG. 8 at a predetermined processing cycle.

In step S801, the on-board apparatus 111 determines whether or not the link distance has been calculated (set). If the on-board apparatus 111 determines that the link distance has been set, the processing proceeds to step S802. If the on-board apparatus 111 determines that the link distance has not been set, the processing ends.

In step S802, the on-board apparatus 111 waits for input of dead reckoning information. For example, the on-board apparatus 111 stands by until the calculation of the dead reckoning position is completed.

In step S803, the on-board apparatus 111 determines whether or not the dead reckoning position has been updated. If the on-hoard apparatus 111 determines that the dead reckoning position has been updated, the processing proceeds to step S804. If the on-board apparatus 111 determines that the dead reckoning position has not been updated, the processing ends.

In step S804, the on-board apparatus 111 determines whether or not there is an intersection with poor visibility. If the on-board apparatus 111 determines that there is an intersection with poor visibility, the processing proceeds to step S805. If the on-board apparatus 111 determines that there is no intersection with poor visibility, the processing ends.

In step S805, the on-board apparatus 111 calculates a vehicle offset. More specifically, the on-board apparatus 111 calculates a relative distance between the map matching position and the dead reckoning position as the vehicle offset.

In step S806, the on-board apparatus 111 calculates an approximate remaining distance. More specifically, the on-board apparatus 111 calculates the approximate remaining distance by subtracting the vehicle offset from the link distance.

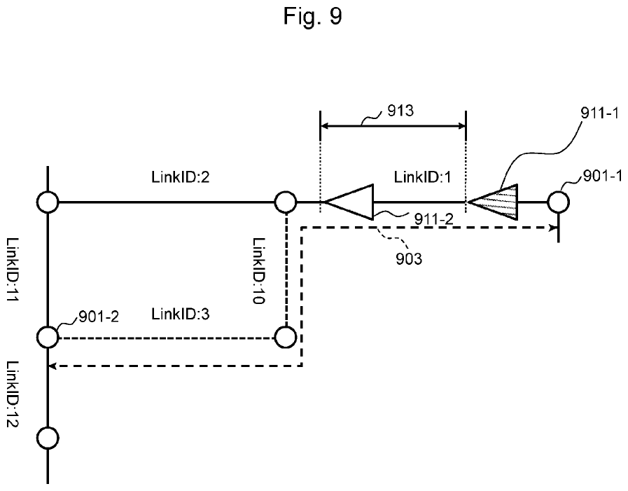

FIG. 9 is a diagram for explaining the approximate remaining distance. In FIG. 9, a case will be described as an example where links of LinkIDs “1”, “10”, “3”, and “12” are acquired in step S701 as links corresponding to a travel route. It is noted that, in the following description, the link with a LinkID of “n” may be referred to as “link n”. Further, a road corresponding to the link n may be referred to as the “road n”. Further, in respect of the vehicle 110 entering an intersection and leaving the intersection, a road on the entry side of the intersection may be referred to as the “entry road”, a link corresponding to the entry road may be referred to as the “entry link”, a road on the exit side of the intersection may be referred to as the “exit road”, and a link corresponding to the exit road may be referred to as the “exit link”. In the present example, it is assumed that the entry road 3 is a narrow road as the entry link 3 is indicated by the broken line, and the exit road 12 is a wide road as the exit link 12 is indicated by the solid line. Accordingly, the intersection corresponding to a node 902 connecting the link 3 to the link 12 is an intersection with poor visibility.

First, by the processing in FIG. 7, a distance from a starting point node 901 of the link 1 to the node 902 which is the intersection node of the intersection with poor visibility, that is, a distance 903 (link distance) from the intersection corresponding to the node 901 to the node 902 is calculated.

Next, by the processing in FIG. 8, a distance 913 (relative distance) between a position 911 indicating the map matching position and a position 912 indicating the dead reckoning position is calculated, and an approximate remaining distance is calculated by subtracting the distance 913 (relative distance) from the distance 903 (link distance).

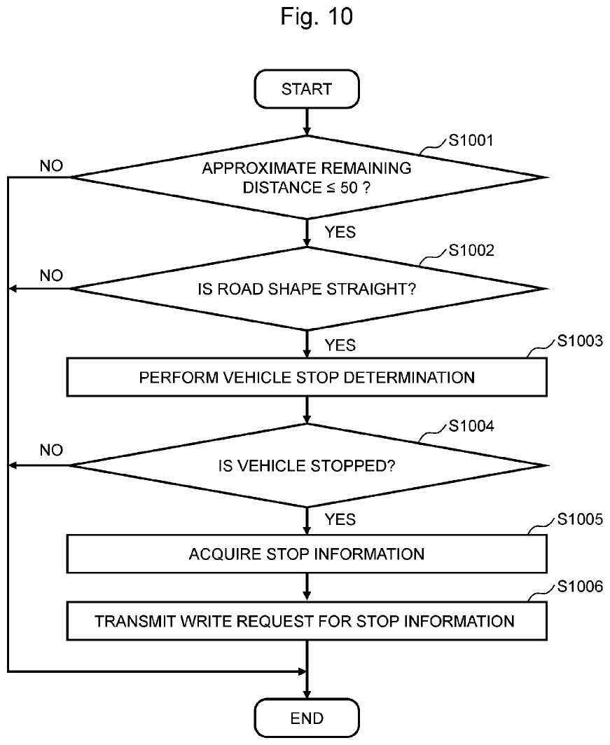

FIG. 10 illustrates an example of a flowchart related to processing of acquiring stop information related to an intersection with poor visibility. The control apparatus 210 of the on-board apparatus 111 executes, for example, the processing illustrated in FIG. 10 at a predetermined processing cycle.

In step S1001, the on-board apparatus 111 determines whether or not the approximate remaining distance is equal to or smaller than a predetermined distance (e.g., 50 m). If the on-board apparatus 111 determines that the approximate remaining distance is equal to or smaller than the predetermined distance, the processing proceeds to step S1002. If the on-board apparatus 111 determines that the approximate remaining distance is not equal to or smaller than the predetermined distance, the processing ends.

In step S1002, the on-board apparatus 111 determines whether or not the shape of the road is straight. If the on-board apparatus 111 determines that the shape of the road is straight, the processing proceeds to step S1003. If the on-board apparatus 111 determines that the shape of the road is not straight, the processing ends. For example, if a sum of azimuth differences of a sequence of links up to the intersection with poor visibility is equal to or smaller than a predetermined value, the on-board apparatus 111 determines that the shape of the road is straight.

According to this processing, it is possible to reduce the possibility that inappropriate stop information is acquired in a road environment where roads are dense in a residential area or the like. Further, for example, even if the road on which the vehicle 110 is traveling cannot be specified because the map matching cannot be performed due to dense roads in a residential area or the like, it is possible to determine whether or not the road is the target for acquiring the stop information, thereby avoiding a situation where the stop information cannot be acquired.

In step S1003, the on-board apparatus 111 performs stop determination for the vehicle 110. For example, the on-board apparatus 111 acquires the speed of the vehicle 110.

In step S1004, the on-board apparatus 111 determines whether or not the vehicle 110 stops (e.g., whether or not the speed of the vehicle 110 is “0”). If the on-board apparatus 111 determines that the vehicle 110 stops, the processing proceeds to step S1005. If the on-board apparatus 111 determines that the vehicle 110 does not stop, the processing ends.

In step S1005, the on-board apparatus 111 acquires stop information that is information related to the stop of the vehicle 110. For example, the on-board apparatus 111 acquires the dead reckoning position when the vehicle 110 stops as a stop position related to an intersection with poor visibility, acquires the azimuth of the vehicle 110 when the vehicle 110 stops as a stop azimuth, and uses the stop position and stop azimuth as the stop information.

In step S1006, the on-board apparatus 111 transmits a write request for stop information to the server apparatus 120. For example, the write request for stop information includes a user ID for identifying the user of the vehicle 110, link information of a narrow road (LinkID, etc.), and event information (EventID indicating acquisition of stop information, EventDATA including the acquired stop information, etc.).

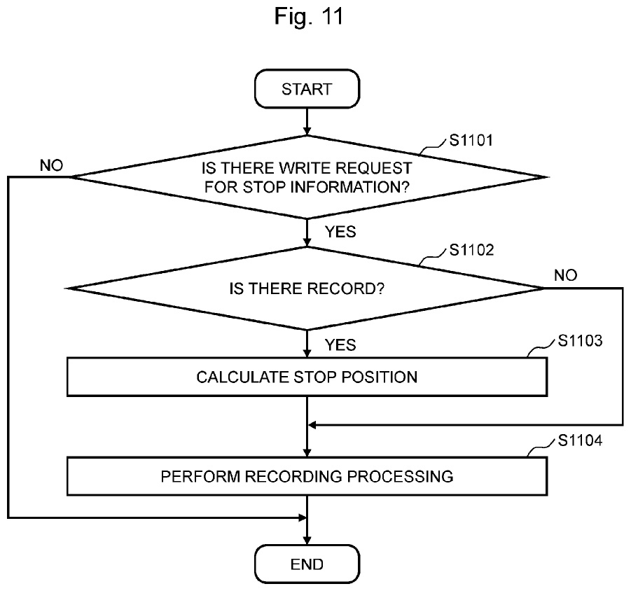

FIG. 11 illustrates an example of a flowchart related to processing of the server apparatus 120 recording the stop information. The control apparatus 310 of the server apparatus 120 executes, for example, the processing illustrated in FIG. 11 at a predetermined processing cycle.

In step S1101, the server apparatus 120 determines whether or not there is a write request for stop information. If the server apparatus 120 determines that there is a write request for stop information, the processing proceeds to step S1102. If the server apparatus 120 determines that there is no write request for stop information, the processing ends.

In step S1102, the server apparatus 120 determines whether or not the stop information has already been associated with the link corresponding to the stop information of the write request (whether or not there is a corresponding record). If the server apparatus 120 determines that there is a corresponding record, the processing proceeds to step S1103. If the server apparatus 120 determines that there is no corresponding record, the processing proceeds to step S1104. For example, the server apparatus 120 specifies the user information of the user of the vehicle 110 from the user information 323 based on the user ID of the write request, and determines from the specified user information whether or not the stop information is stored in EventDATA for the link of LinkID in the write request and for the event of EventID in the write request.

In step S1103, the server apparatus 120 calculates a slop position (set value). For example, the server apparatus 120 calculates a probable stop position as a set value using a statistical model. More specifically, the server apparatus 120 performs filtering processing (clustering) on all stop positions of the same link to remove noise and calculate a representative value (e.g., an average value).

For example, when the vehicle 110 is traveling in a residential area and gives priority to a pedestrian, the vehicle 110 may temporarily stop. Such a temporary stop is not a stop related to an intersection with poor visibility, so that it is unnecessary data and causes a decrease in accuracy of a stop position related to an intersection with poor visibility. In this regard, performing the clustering in the vehicle 110 makes it possible to exclude the data on the temporary stop and thus to enhance the accuracy of the stop position related to the intersection with poor visibility.

It is noted that the server apparatus 120 performs the same processing on the stop azimuth as on the stop position.

In step S1104, the server apparatus 120 performs recording processing. For example, the server apparatus 120 records (stores) the stop information of the write request in association with the link information. Further, for example, the server apparatus 120 records the acquired stop information or the calculated representative value in association with the link information (in EventDATA for the link of LinkID in the write request and for the event of EventID in the write request).

It is noted that the on-board apparatus 111 may be configured to execute the processing illustrated in FIG. 11. In this case, from the viewpoint of the data capacity, the on-board apparatus 111 may calculate, for example, the representative value to calculate “the previous value×0.8+the current value×0.2” without storing the stop information of the write request in association with the link information.

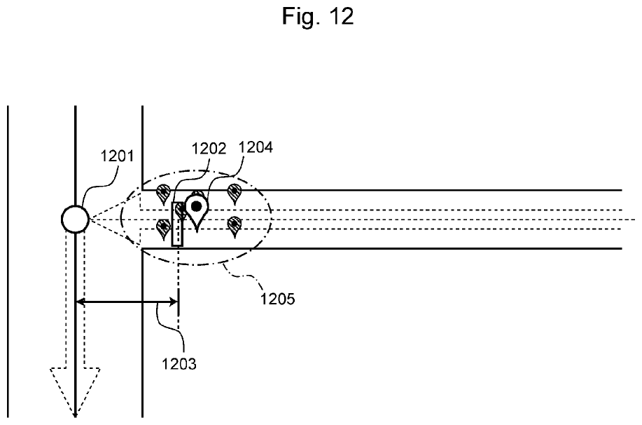

FIG. 12 is a diagram for explaining the stop position.

Conventionally, a distance from the position of the vehicle 110 to a node 1201 of an intersection with poor visibility is calculated as a distance up to the stop of the vehicle 110 (exact remaining distance). Specifically, the conventional remaining distance includes a distance 1203 from the node 1201 to an actual stop line 1202 as an error. Here, the remaining distance that the ADAS unit expects is not the distance from the position of the vehicle 110 to the node 1201 of the intersection, but the distance from the position of the vehicle 110 to the stop line 1202.

In this regard, in order to reduce the above-described error, the vehicle 110 estimates the stop position of the vehicle 110 related to an intersection with poor visibility (e.g., obtaining a representative value 1204 of the stop position) to enhance the accuracy of information to be provided to the ADAS unit.

As illustrated in FIG. 12, when a plurality of stop positions are recorded, a cluster 1205 is provided by clustering, and stop positions that become noise outside the cluster 1205 are excluded. Subsequently, the representative value 1204 is calculated from the stop positions in the cluster 1205.

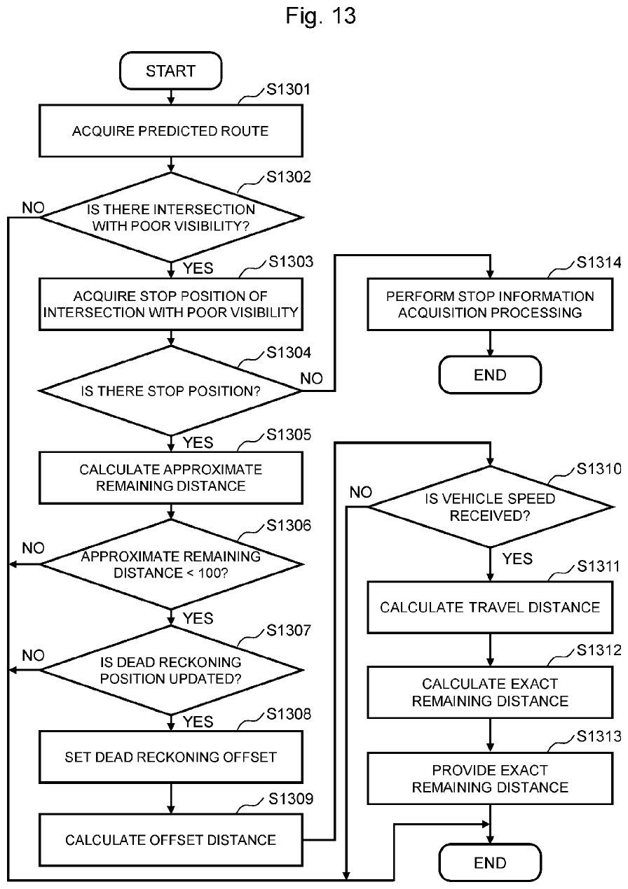

FIG. 13 illustrates an example of a flowchart related to processing of calculating a distance from the current position of the vehicle 110 to a stop position (including a position to be the representative value). The control apparatus 210 of the on-board apparatus 111 executes, for example, the processing illustrated in FIG. 13 at a predetermined processing cycle.

In step S1301, the on-board apparatus 111 acquires a predicted route. For example, the on-board apparatus 111 acquires links from the current location to the destination from the map information 222.

In step S1302, the on-hoard apparatus 111 determines whether or not there is an intersection with poor visibility. If the on-board apparatus 111 determines that there is an intersection with poor visibility, the processing proceeds to step S1303. If the on-board apparatus 111 determines that there is no intersection with poor visibility, the processing ends.

It is noted that the on-board apparatus 111 performs the same processing as steps S702 and S707 in steps S1301 and S1302, but a description thereof will be omitted.

In step S1303, the on-board apparatus 111 acquires (requests) the stop position of the intersection with poor visibility from the server apparatus 120. The on-board apparatus 111 transmits a request for specifying a user ID, link information on a narrow road of the intersection with poor visibility (e.g., LinkID of a narrow road), and event information (e.g., EventID indicating acquisition of stop information) to the server apparatus 120. The server apparatus 120 searches the user information 323 for the requested stop position, and transmits the search result to the on-board apparatus 111.

In step S1304, the on-board apparatus 111 determines whether or not there is a stop position of the intersection with poor visibility. If the on-board apparatus 111 determines that there is a stop position of the intersection with poor visibility, the processing proceeds to step S1305. If the on-board apparatus 111 determines that there is no stop position of the intersection with poor visibility, the processing proceeds to step S1314.

In step S1305, the on-board apparatus 111 calculates a link distance and a vehicle offset to calculate an approximate remaining distance, as in the processing illustrated in FIGS. 7 and 8.

In step S1306, the on-board apparatus 111 determines whether or not the approximate remaining distance is within a predetermined distance (e.g., 100 m). If the on-board apparatus 111 determines that the approximate remaining distance is within the predetermined distance, the processing proceeds to step S1307. If the on-board apparatus 111 determines that the approximate remaining distance is not within the predetermined distance, the processing ends.

In step S1307, the on-board apparatus 111 determines whether or not the dead reckoning position has been updated. If the on-board apparatus 111 determines that the dead reckoning position has been updated, the processing proceeds to step S1308. If the on-board apparatus 111 determines that the dead reckoning position has not been updated, the processing ends.

In step S1308, the on-board apparatus 111 sets the dead reckoning position as a dead reckoning offset.

In step S1309, the on-board apparatus 111 calculates a distance (offset distance) from the dead reckoning offset to the stop position.

In step S1310, on-hoard apparatus 111 determines whether or not the speed of vehicle 110 has been received (measured). If the on-board apparatus 111 determines that the speed of the vehicle 110 has been received, the processing proceeds to step S1311. If the on-board apparatus 111 determines that the speed of the vehicle 110 has not been received, the processing ends.

In step S1311, the on-board apparatus 111 calculates a distance traveled by the vehicle 110 (travel distance) from the dead reckoning offset based on the received speed of the vehicle 110, the time at which the dead reckoning position was acquired, and the current time.

In step S1312, the on-board apparatus 111 calculates a distance (exact remaining distance) from the current position of the vehicle 110 to the stop position. More specifically, the on-board apparatus 111 calculates the exact remaining distance by subtracting the travel distance from the offset distance.

In step S1313, the on-board apparatus 111 provides the calculated exact remaining distance to the ADAS unit, the display control unit 404, and the like. For example, when the on-board apparatus 111 transmits the exact remaining distance to the ADAS unit, the ADAS unit provides appropriate driving assistance for the intersection with poor visibility based on the exact remaining distance in consideration of a position to stop with respect to the intersection with poor visibility, for example, by means of informing that the vehicle 110 is required to decelerate or stop. Further, for example, when the on-board apparatus 111 transmits the exact remaining distance to the display control unit 404, the on-board apparatus 111 provides appropriate driving assistance for the intersection with poor visibility, for example, by means of highlighting a stop line displayed on the NAVI screen or displaying that it is necessary to stop.

In step S1314, the on-board apparatus 111 performs stop information acquisition processing (the processing in FIGS. 10 and 11).

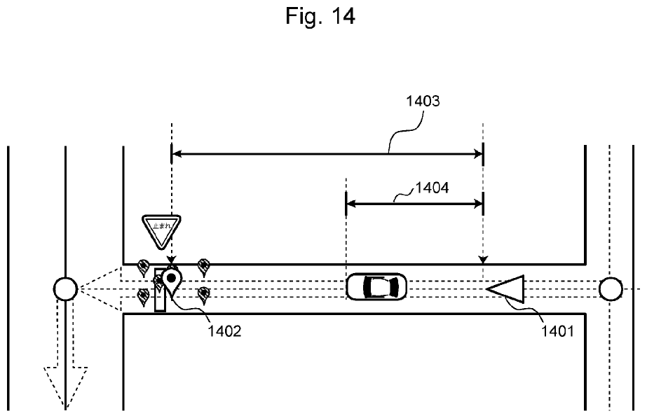

FIG. 14 is a diagram for explaining the exact remaining distance.

First, an offset distance 1403 is calculated which is a distance from a position 1401 indicating the dead reckoning position to a position 1402 indicating the stop position. Subsequently, at the timing when the speed of the vehicle 110 is acquired, a travel distance 1404 from the position 1401 is calculated based on the speed of the vehicle 110, and an exact remaining distance is calculated by subtracting the travel distance 1404 from the offset distance 1403.

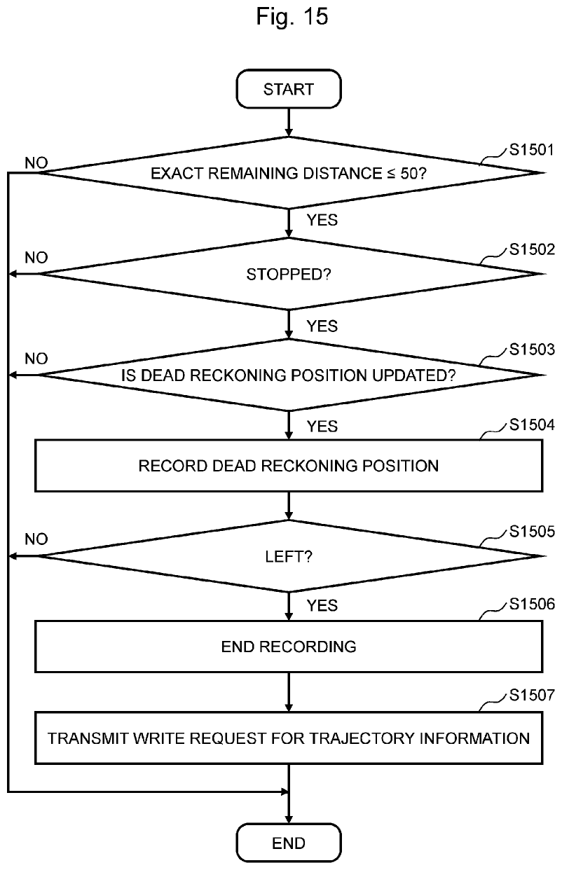

FIG. 15 illustrates an example of a flowchart related to processing of the on-board apparatus 111 acquiring trajectory information. The control apparatus 210 of the onboard apparatus 111 executes, for example, the processing illustrated in FIG. 15 at a predetermined processing cycle.

In step S1501, the on-board apparatus 111 determines whether or not the exact remaining distance is within a predetermined distance (e.g., 50 m). If the on-hoard apparatus 111 determines that the exact remaining distance is within the predetermined distance, the processing proceeds to step S1502. If the on-board apparatus 111 determines that the exact remaining distance is not within the predetermined distance, the processing ends.

In step S1502, the on-board apparatus 111 determines whether or not the vehicle 110 stops at the intersection with poor visibility. If the on-board apparatus 111 determines that the vehicle 110 stops, the processing proceeds to step S1503. If the on-board apparatus 111 determines that the vehicle 110 does not stop, the processing ends.

In step S1503, the on-board apparatus 111 determines whether or not the dead reckoning position has been updated. If the on-board apparatus 111 determines that the dead reckoning position has been updated, the processing proceeds to step S1504. If the on-board apparatus 111 determines that the dead reckoning position has not been updated, the processing ends.

In step S1504, the on-board apparatus 111 records the dead reckoning position. In this way, the on-board apparatus 111 records the dead reckoning position every time the dead reckoning position is updated after the vehicle 110 stops at the intersection with poor visibility.

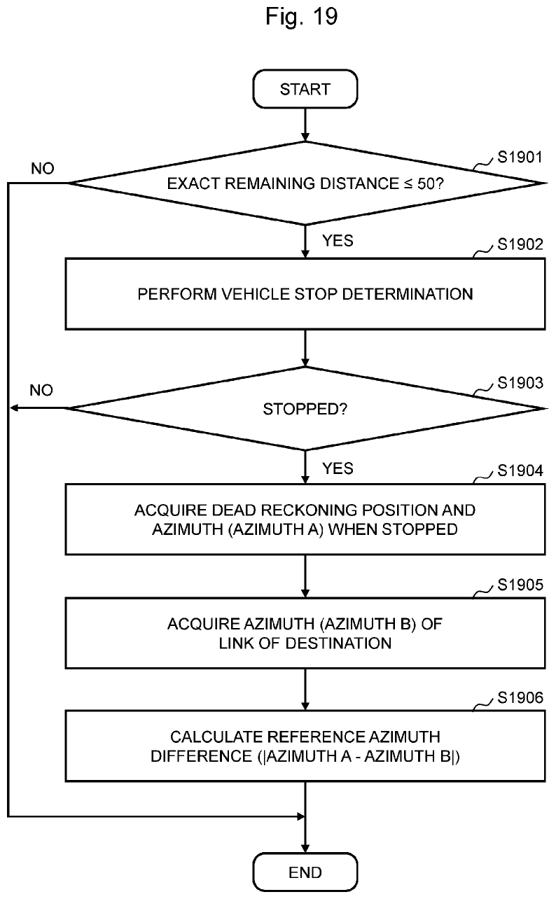

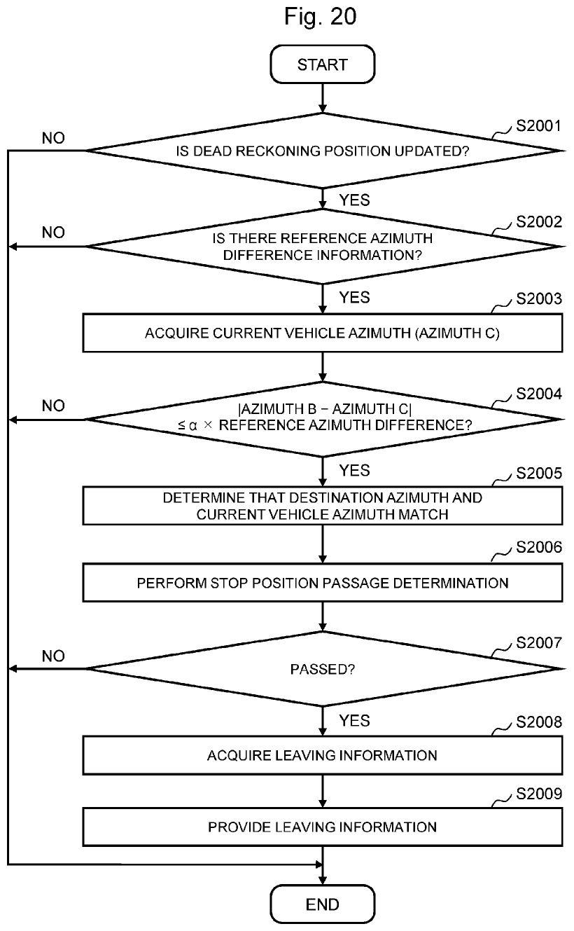

In step S1505, the on-board apparatus 111 determines whether or not the vehicle 110 has left the intersection with poor visibility. If the on-hoard apparatus 111 determines that the vehicle 110 has left the intersection with poor visibility, the processing proceeds to step S1506, If the on-board apparatus 111 determines that the vehicle 110 has not left the intersection with poor visibility, the processing ends. It is noted that whether or not the vehicle 110 has left the intersection with poor visibility can be determined by, for example, the processing illustrated in FIGS. 19 and 20.

In step S1506, the on-board apparatus 111 ends the recording of the dead reckoning position.

In step S1507, the on-board apparatus 111 transmits a write request for trajectory information to the server apparatus 120. For example, the write request for trajectory information includes a user ID for identifying the user of the vehicle 110, link information of a wide road (LinkID, etc.), and event information (EventID indicating acquisition of trajectory information, EventDATA including the acquired trajectory information, etc.).

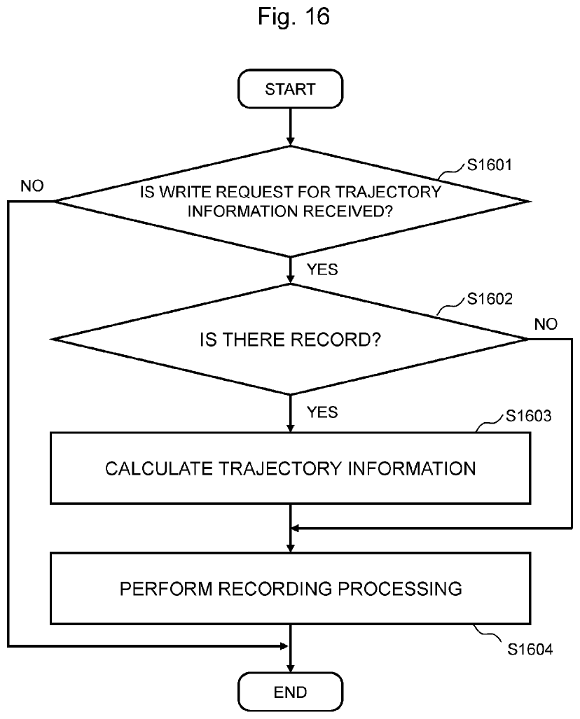

FIG. 16 illustrates an example of a flowchart related to processing of the server apparatus 120 recording trajectory information. The control apparatus 310 of the server apparatus 120 executes, for example, the processing illustrated in FIG. 16 at a predetermined processing cycle.

In step S1601, the server apparatus 120 determines whether or not the write request for trajectory information has been received. If the server apparatus 120 determines that the write request for trajectory information has been received, the processing proceeds to step S1602. If the server apparatus 120 determines that the write request for trajectory information has not been received, the processing ends.

In step S1602, the server apparatus 120 determines whether or not the trajectory information has already been associated with the link corresponding to the trajectory information of the write request (whether or not there is a corresponding record). If the server apparatus 120 determines that there is a corresponding record, the processing proceeds to step S1603. If the server apparatus 120 determines that there is no corresponding record, the processing proceeds to step S1604. For example, the server apparatus 120 specifies the user information of the user of the vehicle 110 from the user information 323 based on the user ID of the write request, and determines from the specified user information whether or not the trajectory information is stored in EventDATA for the link of LinkID in the write request and for the event of EventID in the write request.

In step S1603, the server apparatus 120 calculates trajectory information. For example, the server apparatus 120 specifies probable trajectory information using a statistical method (e.g., regression analysis). It is noted that the on-board apparatus 111 may be configured to perform the processing illustrated in FIG. 16. When the processing is performed by the on-hoard apparatus 111, for example, from the viewpoint of hardware resources, the on-board apparatus 111 may be configured to clear the trajectory information and record the trajectory information of the write request (to hold the latest trajectory information).

In step S1604, the server apparatus 120 performs recording processing. For example, the server apparatus 120 records (stores) the trajectory information of the write request in association with the link information. Further, for example, the server apparatus 120 records the acquired trajectory information or the calculated trajectory information in association with the link information (in EventDATA for the link of LinkID in the write request and for the event of EventID in the write request).

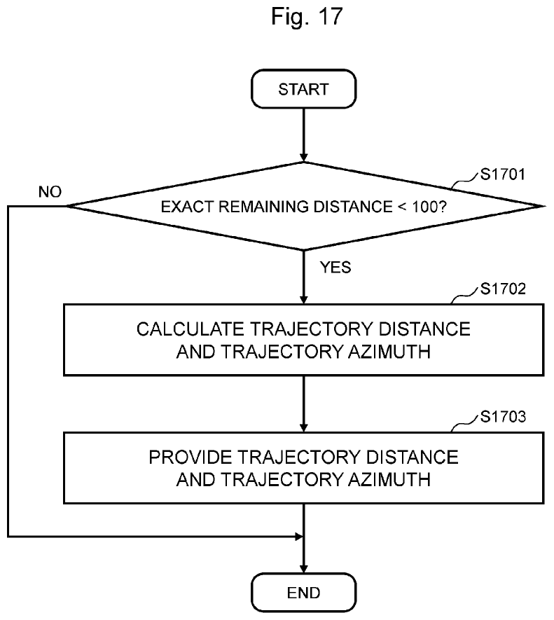

FIG. 17 illustrates an example of a flowchart related to processing of the on-board apparatus 111 calculating a distance and an azimuth from the current position of the vehicle 110 to the trajectory information. The control apparatus 210 of the on-board apparatus 111 executes, for example, the processing illustrated in FIG. 17 at a predetermined processing cycle.

In step S1701, the on-board apparatus 111 determines whether or not the exact remaining distance is within a predetermined distance (e.g., 100 m). If the on-board apparatus 111 determines that the exact remaining distance is within the predetermined distance, the processing proceeds to step S1702. If the on-board apparatus 111 determines that the exact remaining distance is not within the predetermined distance, the processing ends.

In step S1702, the on-board apparatus 111 calculates a distance (trajectory distance) and an azimuth (trajectory azimuth) from the current position of the vehicle 110 to the trajectory information. More specifically, the on-board apparatus 111 acquires (requests) the trajectory information of the intersection with poor visibility from the server apparatus 120. The on-board apparatus 111 transmits a request for specifying a user ID, link information on a wide road of the intersection with poor visibility (e.g., LinkID of a wide road), and event information (e.g., EventID indicating acquisition of trajectory information) to the server apparatus 120. The server apparatus 120 searches the user information 323 for the requested trajectory information, and transmits the search result to the on-board apparatus 111. The on-board apparatus 111 receives the search result, calculates as a trajectory distance a distance between the current position of the vehicle 110 and the position at which the recording of the trajectory information was started, and calculates as a trajectory azimuth an azimuth from the current position of the vehicle 110 to the position at which the recording of the trajectory information was started.

In step S1703, the on-board apparatus 111 provides the calculated trajectory distance and trajectory azimuth to the ADAS unit, the display control unit 404, and the like. For example, providing the trajectory position to the ADAS unit makes it possible to provide driving assistance for the intersection with poor visibility, such as controlling the speed of the vehicle 110 when the vehicle 110 passes through the intersection. Further, for example, providing the trajectory position to the display control unit 404 makes it possible to provide driving assistance for the intersection with poor visibility, such as displaying a travel route, a radius of curvature, and the like on the NAVI screen.

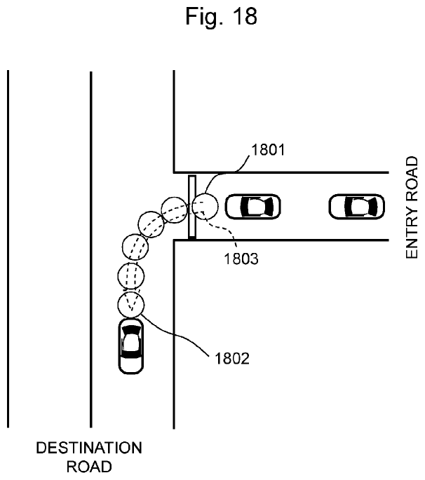

FIG. 18 is a diagram for explaining the trajectory information.

As illustrated in FIG. 18, every time the dead reckoning position is updated, the dead reckoning position is acquired as a trajectory 1803 of the vehicle 110 from an entrance point 1801 to an exit point 1802 of the intersection with poor visibility.

FIG. 19 illustrates an example of a flowchart related to processing of the on-board apparatus 111 calculating a reference azimuth difference. The control apparatus 210 of the on-board apparatus 111 executes, for example, the processing illustrated in FIG. 19 at a predetermined processing cycle.

In step S1901, the on-board apparatus 111 determines whether or not the exact remaining distance is within a predetermined distance (e.g., 50 m). If the on-board apparatus 111 determines that the exact remaining distance is within the predetermined distance, the processing proceeds to step S1902. If the on-board apparatus 111 determines that the exact remaining distance is not within the predetermined distance, the processing ends.

In step S1902, the on-board apparatus 111 performs stop determination for the vehicle 110. For example, the on-board apparatus 111 acquires the speed of the vehicle 110.

In step S1903, the on-board apparatus 111 determines whether or not the vehicle 110 stops (e.g., whether or not the speed of the vehicle 110 is “0”). If the on-board apparatus 111 determines that the vehicle 110 stops, the processing proceeds to step S1904. If the on-board apparatus 111 determines that the vehicle 110 does not stop, the processing ends.

In step S1904, the on-board apparatus 111 acquires the dead reckoning position and the azimuth (hereinafter, referred to as azimuth A) when the vehicle 110 stops.

In step S1905, the on-board apparatus 111 acquires the azimuth of the link of the destination after leaving (hereinafter, referred to as azimuth B).

In step S1906, the on-board apparatus 11 calculates a reference azimuth difference (|azimuth A−azimuth B|).

FIG. 20 illustrates an example of a flowchart related to processing of the on-board apparatus 111 determining leaving the intersection with poor visibility. The control apparatus 210 of the on-board apparatus 111 executes, for example, the processing illustrated in FIG. 20 at a predetermined processing cycle.

In step S2001, the on-board apparatus 111 determines whether or not the dead reckoning position has been updated. If the on-board apparatus 111 determines that the dead reckoning position has been updated, the processing proceeds to step S2002. If the on-board apparatus 111 determines that the dead reckoning position has not been updated, the processing ends.

In step S2002, the on-board apparatus 111 determines whether or not the reference azimuth difference has been calculated. If the on-board apparatus 111 determines that the reference azimuth difference has been calculated, the processing proceeds to step S2003. If the on-board apparatus 111 determines that the reference azimuth difference has not been calculated, the processing ends.

In step S2003, the on-board apparatus 111 acquires the current azimuth of the vehicle 110 (hereinafter, referred to as azimuth C).

In step S2004, the on-board apparatus 111 determines whether or not a predetermined condition (|azimuth B−azimuth C|<=α×reference azimuth difference) is satisfied (whether azimuth C matches the azimuth of the destination road after leaving). If the on-board apparatus 111 determines that the predetermined condition is satisfied, the processing proceeds to step S2005. If the on-board apparatus 111 determines that the predetermined condition is not satisfied, the processing ends. Here, a is a predetermined coefficient (e.g., 0.3). Furthermore, “A<=B” means B is equal to or more than A, and “A>=B” means B is equal to or less than A.

In step S2005, the on-board apparatus 111 determines that azimuth C matches the azimuth of the destination road after leaving.

In step S2006, the on-board apparatus 111 performs stop position passage determination. For example, a stop position of the intersection with poor visibility is acquired (requested) from the server apparatus 120.

In step S2007, the on-board apparatus 111 determines whether or not the vehicle has passed the stop position. If the on-board apparatus 111 determines that the vehicle has passed the stop position, the processing proceeds to step S2008. If the on-board apparatus 111 determines that the vehicle has not passed the stop position, the processing ends.

In step S2008, the on-board apparatus 111 acquires leaving information indicating that the vehicle has left the intersection with poor visibility.

In step S2009, the on-board apparatus 111 transmits the leaving information to the ADAS unit or the like. For example, providing the leaving information to the ADAS unit makes it possible to end driving assistance for the intersection with poor visibility at an appropriate timing.

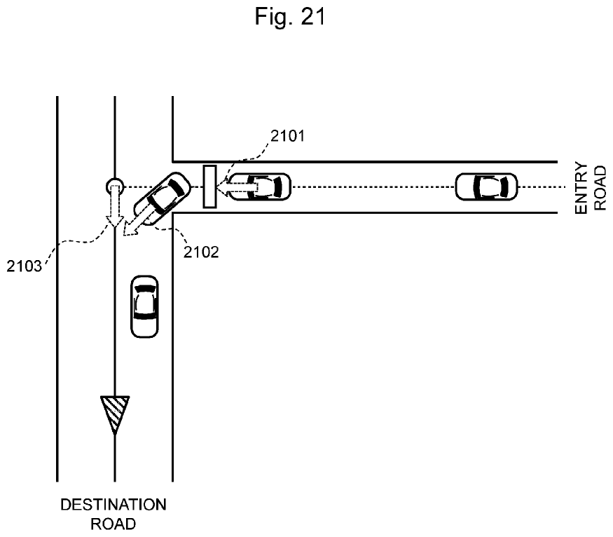

FIG. 21 is a diagram for explaining determination of leaving.

Conventionally, determination as to whether or not a vehicle has left an intersection with poor visibility has been performed at the time of map matching. The map matching is performed at a predetermined interval (e.g., one second). However, for the vicinity of an intersection where a plurality of roads intersect, the vicinity of an intersection with dense roads, and the like, it is hard to determine which road the vehicle 110 is to be matched. In some cases, the map matching cannot be performed unless the vehicle 110 has traveled about several tens of meters (e.g., 50 m). In such a case, the timing of issuing an instruction to end driving assistance for an intersection with poor visibility to the ADAS unit is delayed.

In this regard, the vehicle 110 determining whether or not the vehicle 110 has left the intersection with poor visibility by using the azimuth of the vehicle 110 at the time of dead reckoning after entering the intersection with poor visibility allows driving assistance to be ended quickly.

As illustrated in FIG. 21, when the vehicle 110 stops, an azimuth 2101 (azimuth A) of the vehicle 110 is acquired. An azimuth 2102 (azimuth C) of the vehicle 110 is acquired each time the dead reckoning position is updated until the vehicle 110 leaves the intersection with poor visibility. If the azimuth 2101, the azimuth 2102, and an azimuth 2103 (azimuth B) of the destination road after leaving satisfy a predetermined condition, it is determined that the vehicle 110 has left the intersection with poor visibility.

It is noted that the driving information providing system 100 does not exclude a determination method using (|azimuth B−azimuth C|)<=30 degrees as a fixed condition. However, in this determination method, if the entry road and the exit road are at an acute angle, the condition is satisfied at the time when the vehicle 110 stops at the position of the stop line, which causes an erroneous determination that the vehicle 110 has left. Therefore, even with such a determination method, when it is determined that the entry road and the exit road are at an acute angle, it is preferable to make the determination using a predetermined condition.

According to the present embodiment, since the stop information related to an intersection is acquired, it is possible to provide driving assistance for the intersection at an appropriate timing.

### (2) Second Embodiment

In the first embodiment, an intersection connecting a narrow road to a wide road is exemplified as an intersection with poor visibility. By contrast, in a second embodiment, an intersection connecting a narrow road to a wide road is a candidate intersection that is a candidate for an intersection connecting a narrow road to a wide road. Whether the candidate intersection is an intersection with poor visibility or a normal intersection (an intersection other than an intersection with poor visibility) is determined based on a result of recognizing an image captured for the candidate intersection.

The following will describe the second embodiment in detail. In the following description, differences from the first embodiment will be mainly focused, and the description of the common points with the first embodiment will be omitted or simplified.

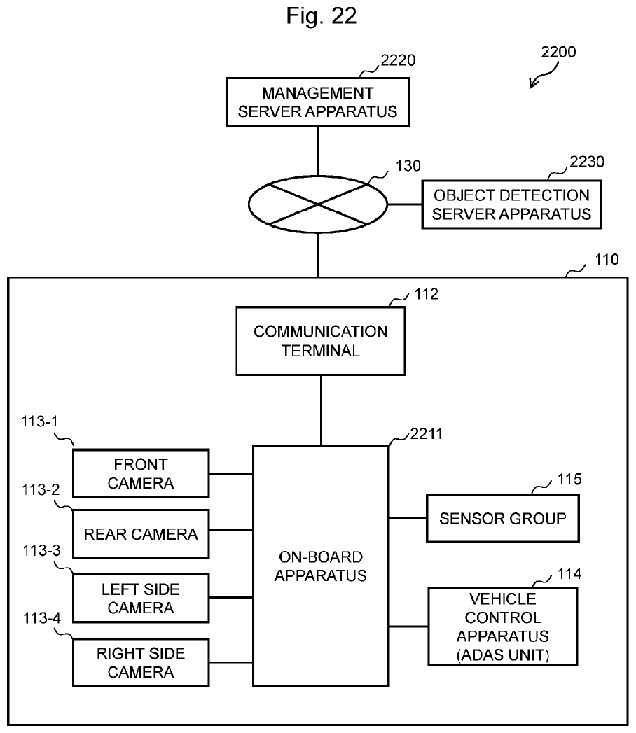

FIG. 22 is a diagram illustrating an example of a configuration of a driving assistance system according to the second embodiment.

A vehicle 110 includes an on-board apparatus 2211 instead of the on-board apparatus 111. The on-board apparatus 2211 captures an image for a candidate intersection determined from the map information 222, and determines whether or not the candidate intersection is an intersection with poor visibility based on a result of recognizing the captured image.

Instead of the server apparatus 120, a management server apparatus 2220 and an object detection server apparatus 2230 are connected to the communication line network 130. The management server apparatus 2220 is an apparatus that manages information saved in the on-board apparatus 2211, and communicates with the on-board apparatus 2211 and the object detection server apparatus 2230. The object detection server apparatus 2230 is an apparatus that performs image recognition of a captured image, and communicates with the management server apparatus 2220. It is noted that the management server apparatus 2220 and the object detection server apparatus 2230 may be an apparatus in which they are integrated. Further, the configuration of the management server apparatus 2220 may be the same as that of the server apparatus 120. Further, at least one of the functions of the management server apparatus 2220 or at least one of the functions of the object detection server apparatus 2230 may be implemented on a computation resource pool such as a cloud platform.

In the present embodiment, for example, the following processing is performed. That is, the on-board apparatus 2211 transmits image data indicating a captured image to the management server apparatus 2220. The management server apparatus 2220 saves the image data and also transmits the image data to the object detection server apparatus 2230. The object detection server apparatus 2230 performs image recognition including determination as to whether or not a predetermined type of object appears in the image indicated by the image data. The object detection server apparatus 2230 returns recognition result information indicating the result of the image recognition to the management server apparatus 2220. The management server apparatus 2220 saves the recognition result information, and transmits the recognition result information to the on-board apparatus 2211. Thus, the on-board apparatus 2211 can obtain the result of the image recognition of the captured image.

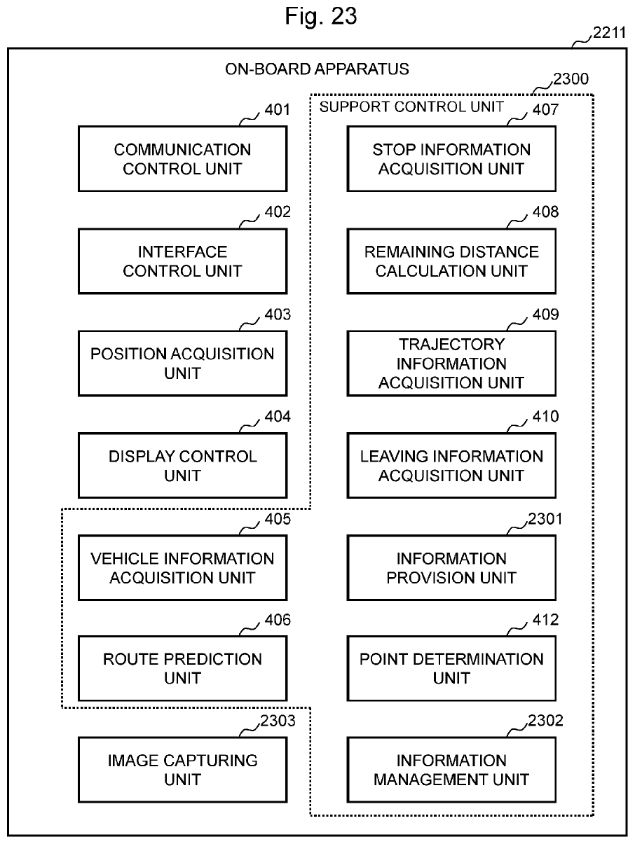

FIG. 23 is a diagram illustrating an example of the functions of the on-board apparatus 2211.

The on-board apparatus 2211 includes, in addition to the functions 401 to 410 and 412 in the first embodiment, an information provision unit 2301 that provides the vehicle control apparatus 114 with information indicating a reliability described below, an information management unit 2302 that associates event information with a LinkID (an example of link information), and an image capturing unit 2303 that captures images with the cameras 113.

It is noted that, in FIG. 23, the functions 405 to 410, 412, 2301, and 2302 can be defined as a support control unit 2300. The image capturing unit 2303 may operate in response to a request from the support control unit 2300. The position acquisition unit 403 performs dead reckoning and map matching. In the present embodiment, the position acquisition unit 403 and the support control unit 2300 cooperate with each other, and the support control unit 2300 causes the image capturing unit 2303 to operate through the cooperation as appropriate, thereby providing driving assistance. Each time the position acquisition unit 403 acquires a vehicle position, information indicating the acquired vehicle position is provided to the support control unit 2300. The position acquisition unit 403 may be included in the support control unit 2300.

One or some of the functions described in the first embodiment (e.g., the stop information acquisition unit 407) may not be provided.

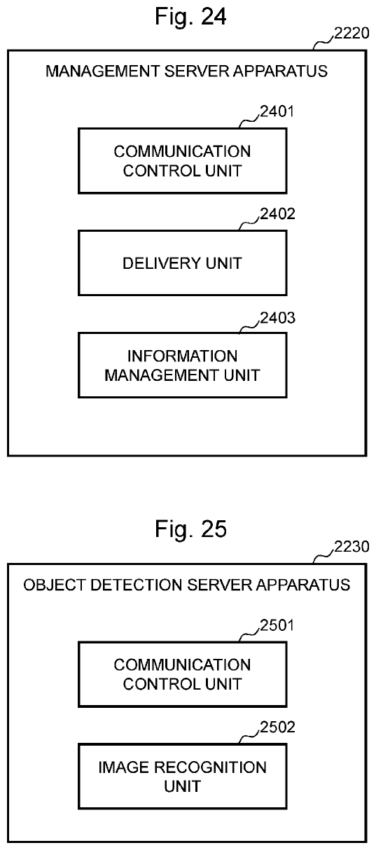

FIG. 24 is a diagram illustrating an example of the functions of the management server apparatus 2220.

The management server apparatus 2220 includes a communication control unit 2401, a delivery unit 2402, and an information management unit 2403.

The communication control unit 2401 performs communication control necessary for communicating with the on-board apparatus 2211 and the object detection server apparatus 2230.

The delivery unit 2402 generates an event file for the user of the on-board apparatus 2211 from the personal event table 600 for the user in response to an event file request from the on-board apparatus 2211, and transmits the generated event file to the onboard apparatus 2211. Further, the delivery unit 2402 transmits the image data from the on-board apparatus 2211 to the object detection server apparatus 2230.

The information management unit 2403 saves the image data from the on-board apparatus 2211, and saves the recognition result information from the object detection server apparatus 2230.

FIG. 25 is a diagram illustrating an example of the functions of the object detection server apparatus 2230.

The object detection server apparatus 2230 includes a communication control unit 2501 and an image recognition unit 2502.

The communication control unit 2501 performs communication control necessary for communicating with the management server apparatus 2220.

The image recognition unit 2502 performs image recognition on the image indicated by the image data from the management server apparatus 2220, and returns a return value including the recognition result information indicating a result of the image recognition to the management server apparatus 2220.

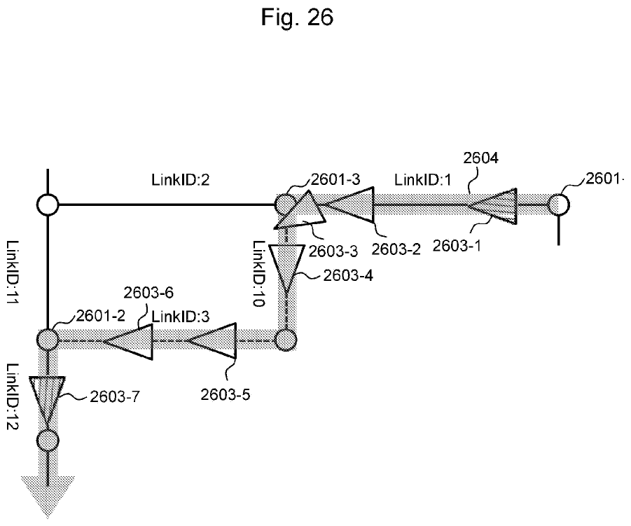

FIG. 26 is a diagram for explaining an outline of the present embodiment. It is noted that, in FIG. 26 as in FIG. 9, links corresponding to narrow roads are represented by broken lines, and links corresponding to wide roads are represented by solid lines. Further, in FIG. 26, among acquired vehicle positions 2603-1 to 2603-7, the vehicle positions 2603-1 and 2603-7 are map matching positions, and the vehicle positions 2603-2 to 2603-6 are dead reckoning positions.

The point determination unit 412 determines from the map information 222 whether or not there is a candidate intersection (a candidate for an intersection with poor visibility). Here, the intersection corresponding to a node 2601-2 that connects the link 3 to the link 12 (the intersection that connects the narrow road 3 to the wide road 12) is a candidate intersection.

If it is determined that there is a candidate intersection, and the vehicle 110 is close to the candidate intersection, the image capturing unit 2303 captures an image using at least the camera 113-1 of the cameras 113-1 to 113-4. Thus, an image at least on the front side of the vehicle 110 (an example of at least a part of the periphery of the vehicle 110) is captured. Image data indicating the image is transmitted from the onboard apparatus 2211 to the object detection server apparatus 2230 via the management server apparatus 2220, and the object detection server apparatus 2230 performs image recognition on the image indicated by the image data. Recognition result information indicating the result of the image recognition is transmitted to the management server apparatus 2220, and event information including the recognition result information is transmitted from the management server apparatus 2220 to the onboard apparatus 2211. The information management unit 2302 associates the event information with a LinkID of a target link that is a link corresponding to a point related to capturing of the image.

Here, the “LinkID of the target link” is a LinkID acquired in map matching in one comparative example. The NAVI (e.g., the position acquisition unit 403) generally performs processing such as map matching and dead reckoning, but does not obtain a route on which the vehicle 110 actually travels (e.g., this is because that, even if a destination is input and a route to the destination is searched for, the vehicle 110 does not always travel on the searched route). Accordingly, the LinkID is generally not acquired by processing other than map matching. This is the reason for using the map matching to acquire the LinkID. However, the map matching may be not performed (or succeeded) depending on a road environment in which the vehicle 110 is in traveling. For example, in FIG. 26, when the vehicle 110 travels on the roads, wide road 1→narrow road 10→narrow road 3→wide road 12 in this order, the road environment including the narrow road 10 and the narrow road 3 is an environment with dense roads, so that the map matching may be performed only on the road 1 and the road 12. In this case, even if an image is captured on the narrow road 3, the road on which the map matching has been performed recently is the wide road 1, and the recently acquired LinkID is “1”, accordingly. Therefore, in one comparative example, the event information including the information indicating the recognition result of the captured image is associated with LinkID “1”. Thus, correct event information is not associated with LinkID “3” and incorrect event information is associated with LinkID “1”, so that appropriate driving assistance may be not provided for the narrow road 3 and the wide road 1.

In the present embodiment, the image capturing is automatically performed without an instruction from the user as described above, but instead or in addition, an image capturing instruction is received from the user via the operating apparatus 260, and the image capturing may be performed in response to the operation instruction. In this case, a point related to the image capturing may be a point serving as a vehicle position at the time when the image capturing is performed in response to receiving the operation instruction from the user, or a point determined based on the vehicle position (e.g., the closest intersection to the vehicle position in the vehicle traveling direction). Thus, the user can be expected to receive driving assistance suitable for the point when traveling at the same point later. It is noted that, as described above, even if the image capturing is performed in response to the image capturing instruction from the user, a problem that the event information is not associated with an appropriate LinkID may occur in one comparative example.

Therefore, in the present embodiment, a travel route predicted by the route prediction unit 406 is used. Specifically, the route prediction unit 406 predicts a travel route of the vehicle 110 based on the individual information 280 including the travel history table 223 indicating the history of links corresponding to roads on which the vehicle 110 has traveled in the past. In FIG. 26, reference numeral 2604 denotes a predicted route (predicted travel route). In this case, the target link (a link corresponding to a point related to image capturing) is a link which is included in the predicted route 2604 and to which a point related to image capturing belongs, or a link which is included in the predicted route 2604, is connected to the point, and corresponds to a road before the vehicle 110 enters the point. Thus, it is possible to specify the LinkID of the link corresponding to the road belonging to the predicted route 2604. If the point related to image capturing is a candidate intersection corresponding to the node 2601-2, the LinkID of the target link is “3”.

Further, in the present embodiment, a remaining distance calculated by the remaining distance calculation unit 408 is also used. Specifically, if it is determined that there is a candidate intersection, the remaining distance calculation unit 408 periodically or aperiodically calculates a remaining distance that is a distance from a recently acquired vehicle position to a reference point according to the candidate intersection. When the remaining distance is smaller than a predetermined distance, the information management unit 2302 predicts that the vehicle 110 is on the narrow road 3 connected to the candidate intersection, and associates the event information with LinkID “3”.

As described above, according to the present embodiment, it is possible to predict that the vehicle 110 is in traveling on the entry road 3 in front of the candidate intersection even if map matching is not performed on the narrow road 3. Accordingly, it is possible to associate event information including information indicating a result of recognizing an image captured for the narrow road 3 with LinkID “3” corresponding to the predicted narrow road 3. As a result, the information provision unit 2301 can provide information suitable for the road environment to one or more ADAS units, and therefore, it is possible to reduce the possibility that driving assistance suitable for the road environment fails to be provided.

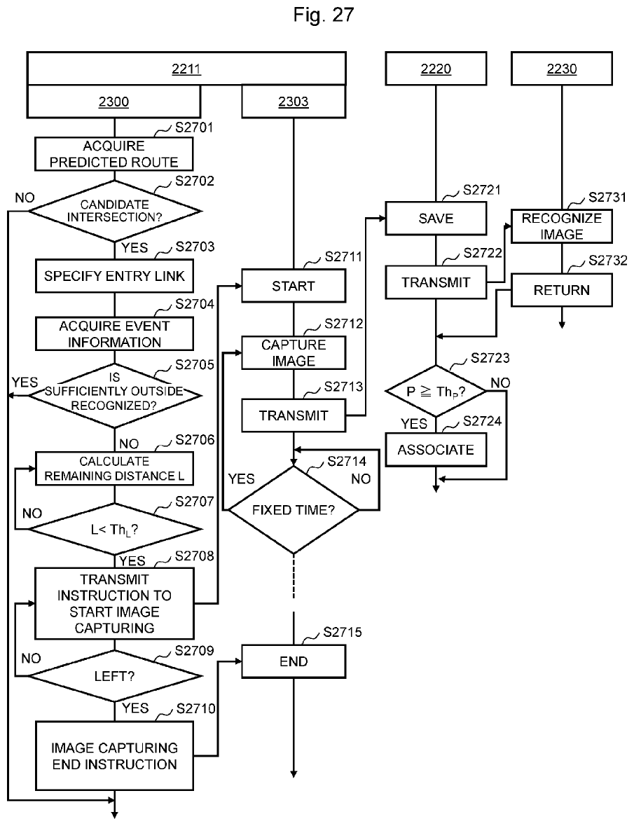

FIG. 27 illustrates an example of a flowchart related to a series of steps of processing related to updating of event information in the management server apparatus 2220. The series of steps of processing may be performed periodically or aperiodically.

In step S2701, the route prediction unit 406 acquires a predicted route. Specifically, the route prediction unit 406 predicts a travel route of the vehicle 110 based on the individual information 280 (e.g., the travel history table 223). In the prediction of the travel route, the map information 222 may be referred to in addition to the individual information 280. It is noted that the prediction of the travel route may be performed each time the vehicle 110 passes through the intersection, or may be performed each time the vehicle 110 departs from the predicted route.

In step S2702, the point determination unit 412 determines from the map information 222 whether or not there are one or more candidate intersections on the predicted route. If there is no candidate intersection on the predicted route, the processing ends. If there are one or more candidate intersections on the predicted route, steps S2703 to S2710 are performed for the candidate intersection closest to the current vehicle position along the predicted route.

In step S2703, the information management unit 2302 specifies an entry link connected to the candidate intersection. In step S2704, the information management unit 2302 obtains the event information associated with the LinkID of the entry link. In step S2705, the information management unit 2302 determines from the acquired event information whether or not the candidate intersection is sufficiently recognized as the outside world. It is noted that the phrase “sufficiently recognized as the outside world” means that the result of image recognition of the captured image of the candidate intersection is sufficiently reliable, for example, that at least one of the following is satisfied.
The value of Probability described below in EventDATA is equal to or larger than a certain value.
A period of time from the current time to the value of LastDate described below is smaller than a certain value.
The ratio of the value of DetectCount described below to the value of CaptureCount described below is equal to or larger than a certain value.

If the candidate intersection is sufficiently recognized as the outside world, the processing ends.

On the other hand, if the candidate intersection is not sufficiently recognized as the outside world, image capturing is performed on the candidate intersection in order to increase the amount and accuracy of recognition as the outside world for the candidate intersection. At that time, the image capturing start timing and the image capturing end timing are controlled.

The control of the image capturing start timing is, for example, as follows. That is, in step S2706, the remaining distance calculation unit 408 calculates a remaining distance L. In step S2707, the information management unit 2302 determines whether or not L<Th_{L}. Here, Th_{L} is a threshold for the remaining distance L (threshold corresponding to the image capturing start timing). If L>=Th_{L}, the processing returns to step S2706. Thus, the calculation of the remaining distance L is performed periodically or aperiodically until L<Th_{L}. If L<Th_{L}, in step S2708, the information management unit 2302 transmits to the image capturing unit 2303 an image capturing start instruction, which is an instruction to start image capturing and also an instruction associated with the LinkID of the entry link specified in step S2703. It is noted that the method of calculating the remaining distance L follows the first embodiment. That is, if there is stop information on the candidate intersection, the remaining distance L is a distance from the vehicle position recently acquired by the position acquisition unit 403 to the stop position in front of the candidate intersection. If there is no stop information for the candidate intersection, the remaining distance L is a distance from the vehicle position recently acquired by the position acquisition unit 403 to the candidate intersection.

In step S2711, the image capturing unit 2303 receives the image capturing start instruction, and starts image capturing in response to the image capturing start instruction. Specifically, in step S2712, the image capturing unit 2303 captures an image with at least the camera 113-1 of the cameras 113-1 to 113-4. In step S2713, the image capturing unit 2303 transmits to the management server apparatus 2220 a set of image data indicating the captured image and the LinkID associated with the image capturing start instruction. In step S2714, the image capturing unit 2303 determines whether or not a certain time has elapsed from step S2712. If the certain time has elapsed, step S2712 is performed. Thus, the image capturing unit 2303 repeats steps S2712 and S2713 periodically or aperiodically until receiving an image capturing end instruction described below.

The following process is performed each time the image data and the LinkID are transmitted by the image capturing unit 2303. That is, in step S2721, in the management server apparatus 2220, the communication control unit 2401 receives the image data and the LinkID, and the information management unit 2403 saves the received image data and LinkID. Specifically, for example, the information management unit 2403 specifies the personal event table 600 for the user from the user information 323, and associates the received image data with the EventDATA 650 corresponding to the received LinkID in the specified personal event table 600. In this way, the image data is stored in the management server apparatus 2220 for the LinkID. In step S2722, the delivery unit 2402 transmits the received image data and LinkID to the object detection server apparatus 2230. In step S2731, in the object detection server apparatus 2230, the communication control unit 2501 receives the image data and the LinkID, and the image recognition unit 2502 performs image recognition on the image indicated by the received image data. In step S2732, the image recognition unit 2502 returns to the management server apparatus 2220 return values including recognition result information indicating the result of the image recognition and the LinkID received from the management server apparatus 2220. The recognition result information includes a value indicating the type of an object recognized as appearing in the image and a value of Probability indicating a probability that the recognition is correct. In step S2723, in the management server apparatus 2220, the communication control unit 2401 receives the return values, and the information management unit 2403 determines whether or not P>=Th_{P}. Here, P is the value of Probability included in the received return values. And, Th_{P} is a threshold for the value of Probability. If P>=Th_{P}, in step S2724, the information management unit 2403 associates the recognition result information included in the return values with the LinkID included in the return values. Specifically, for example, the information management unit 2403 specifies the personal event table 600 for the user from the user information 323, and reflects the recognition result information included in the return values on the EventDATA 650 corresponding to the LinkID included the return values in the specified personal event table 600. It is noted that if P<Th_{P}, step S2724 is skipped. As a result, information indicating an image recognition result with a low value of Probability (i.e., low reliability) is reflected on the EventDATA 650, and as a result, it can be expected that the reliability of the EventDATA 650 is prevented from being reduced.

After transmitting the image capturing start instruction, the on-board apparatus 2211 controls the image capturing end timing. The control of the image capturing end timing is, for example, as follows. That is, in step S2709, the information management unit 2302 determines whether or not the leaving information acquisition unit 410 has specified that the vehicle 110 has left the candidate intersection. If it is specified that the vehicle 110 has left the candidate intersection, in step S2710, the information management unit 2302 transmits to the image capturing unit 2303 an image capturing end instruction which is an instruction to end the image capturing and also an instruction associated with the LinkID of the entry link.

In step S2715, the image capturing unit 2303 receives the image capturing end instruction, and ends the image capturing in response to the image capturing end instruction.

In FIG. 27, a period from steps S2708 to S2710 is a period in which image capturing is performed periodically or aperiodically. The information management unit 2302 causes the image capturing unit 2303 to stop the image capturing while it is determined that the vehicle 110 stops in the period in which image capturing is performed periodically or aperiodically. For example, if it is determined that the vehicle 110 stops (e.g., if it is determined that the acquired vehicle position remains unchanged for a certain period of time), the information management unit 2302 transmits an instruction to stop the image capturing to the image capturing unit 2303. If it is determined that the vehicle 110 starts to move (e.g., if it is determined that the acquired vehicle position is different from the vehicle position acquired immediately before), the information management unit 2302 transmits an instruction to restart the image capturing to the image capturing unit 2303. As a result, it is possible to prevent the same image from being repeatedly captured.

It is noted that, according to FIG. 27, the image capturing unit 2303 performs image capturing periodically or aperiodically from the reception of the image capturing start instruction to the reception of the image capturing end instruction, but instead, the information management unit 2302 may transmit an image capturing instruction to the image capturing unit 2303 periodically or aperiodically so that the image capturing unit 2303 performs image capturing periodically or aperiodically.

Further, according to FIG. 27, the image capturing unit 2303 transmits image data to the management server apparatus 2220 every time image capturing is performed, but instead, the image capturing unit 2303 may transmit image data indicating two or more untransmitted captured images to the management server apparatus 2220 every time image capturing is performed x times (x is an integer of two or more), every period of time of T (T is, for example, twice or more of the image capturing cycle), or when the image capturing end instruction is received. In this case, the management server apparatus 2220 may save the image data and also transmit the image data to the object detection server apparatus 2230. The object detection server apparatus 2230 may perform image recognition on each of two or more images indicated by the image data, and return recognition result information indicating the result of image recognition of each of the two or more images to the management server apparatus 2220. The management server apparatus 2220 may reflect the recognition result information of the two or more images on the EventDATA 650 corresponding to the LinkID of the entry link.

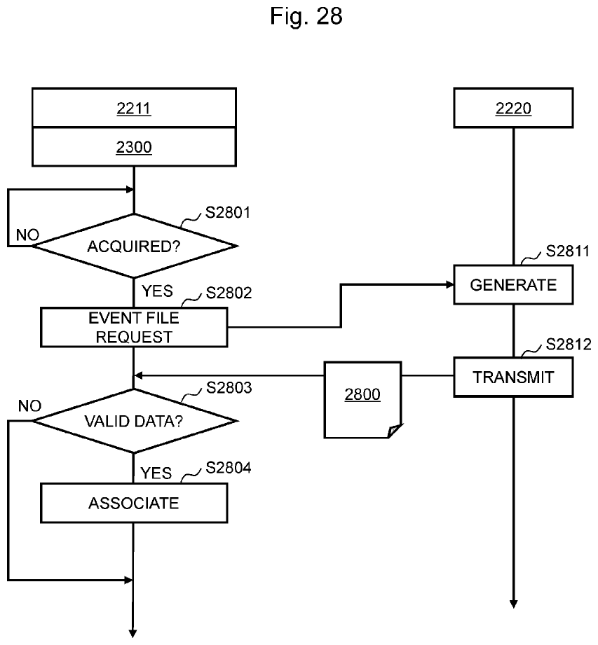

FIG. 28 illustrates an example of a flowchart related to a series of steps of processing related to updating of the event information in the on-board apparatus 2211. The series of steps of processing may be performed periodically or aperiodically.

In step S2801, the information management unit 2302 determines whether or not the processing start time is an event acquisition timing (a timing at which an event file is acquired from the management server apparatus 2220). For example, the event acquisition timing may be any of the following.
When the power supply of the on-board apparatus 2211 is turned on.
When it is specified that EventDATA corresponding to the LinkID of the entry link does not include recognition result information (e.g., values of RoadObject, Probability, and LastDate described below).

If the processing start time is the event acquisition timing, in step S2802, the information management unit 2302 transmits an event file request to the management server apparatus 2220.

In step S2811, the delivery unit 2402 of the management server apparatus 2611 generates an event file 2800 based on the personal event table 600 for the user of the on-board apparatus 2211 which is the transmission source in response to the event file request. In step S2812, the delivery unit 2402 transmits the generated event file 2800 to the on-board apparatus 2211.

In step S2803, in the on-board apparatus 2211, the information management unit 2302 determines whether or not the event file 2800 from the management server apparatus 2220 includes valid data (an example of the “valid data” will be described below). If valid data is included, in step S2804, the information management unit 2302 reflects the valid data in a record having the LinkID corresponding to the valid data in the personal event table 224. As a result, the valid data in the event information in the event file 2800 is associated with the LinkID.

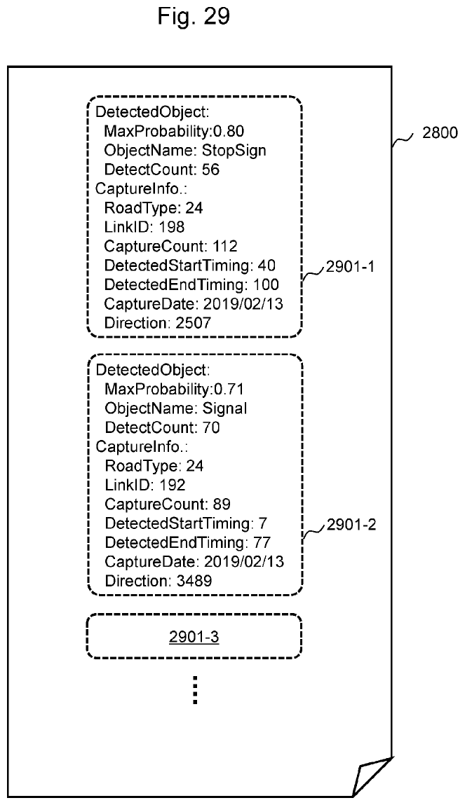

FIG. 29 is a diagram illustrating an example of the event file 2800.

The event file 2800 has information sets 2901. One information set 2901 corresponds to one image capturing period (a period from the start to the end of image capturing) related to one LinkID. Accordingly, for example, when the vehicle travels on the same entry road a plurality of times, a plurality of information sets 2901 are included for the LinkID corresponding to the entry road. Hereinafter, one information set 2901 is taken as an example. Here, the LinkID corresponding to the information set 2901 is referred to as the “target LinkID” in the description of FIG. 29, and the image capturing period corresponding to the information set 2901 is referred to as the “target image capturing period” in the description of FIG. 29.

The information set 2901 includes DetectedObject and CaptureInfo.

DetectedObject is information on an object (an object appearing in the image) detected from an image of a road (and an intersection) corresponding to the target LinkID by image recognition of the image captured during the target image capturing period. Information items of values (information) included in DetectedObject include, for example, MaxProbability, ObjectName, and DetectCount.

MaxProbability is an information item in which the largest value of Probability in return values (return values from the object detection server apparatus 2230) is set corresponding to the target LinkID and related to the image captured in the target image capturing period.

ObjectName is an information item in which a value indicating the type of the detected object is set. The value of ObjectName is “StopSign” or “Signal”. The value “StopSign” means a temporary stop object. The temporary stop object may be a sign installed near a stop position regulated near an intersection (e.g., a sign indicating a temporal stop regulated in a national law or the like), or may be a mark or a character string drawn on a road (e.g., a mark indicating a stop position, or a character string “STOP”). The value “Signal” means a predetermined type of traffic light (e.g., a traffic light other than exceptions such as single signal types of constant blinking light and night blinking light). It is noted that, in the present embodiment, the types of objects to be detected are “StopSign” and “Signal”, but in addition, other types of objects may be detected. For example, from images captured by the left side camera 113-3 and the right side camera 113-4, a blocking object may be detected that is an object having an equal height to or being higher than a predetermined height (e.g., a height defined as the position of the user's eyes). In this case, for example, when there is a blocking object instead of or in addition to the presence of “StopSign”, the candidate intersection may be determined to be an intersection with poor visibility.

DetectCount is an information item in which a value is set that indicates the number of images in which an object of the type indicated by the value of ObjectName associated with the target LinkID is detected among the images captured during the target image capturing period. It is noted that “object detected” means that the value of Probability in the return value from the object detection server apparatus 2230 for the detected object is equal to or larger than Th_{P}, as described below.

CaptureInfo. is information on image capturing of a road (and an intersection) corresponding to the target LinkID during the target image capturing period. Information items for values (information) included in CaptureInfo. include, for example, RoadType, LinkID, CaptureCount, DetectedStartTiming, DetectedEndTiming, CaptureDate, and Direction. The description of RoadType, LinkID, and Direction has already been described, so it is omitted.

CaptureCount is an information item in which a value is set that indicates the number of images captured during the target image capturing period for the target LinkID.

DetectedStartTiming is an information item in which a value that indicates the number of images when the value of Probability of a captured image reaches a value equal to or larger than a first threshold (e.g., Th_{P}) from a value smaller than the first threshold n times or more (n is a natural number) during the target image capturing period is set. DetectedEndTiming is an information item in which a value is set that indicates the number of images when the value of Probability of a captured image reaches a value smaller than a second threshold (e.g., Th_{P}) from a value equal to or larger than the second threshold m times or more (m is a natural number) during the target image capturing period. The second threshold is the same as or different from the first threshold. Further, the value of m is the same as or different from the value of n. For the sake of simplicity, n=m=1. The value of Probability typically increases as the vehicle approaches the candidate intersection and decreases as the vehicle moves away from the candidate intersection.

CaptureDate is an information item in which a value indicating the date of image capturing is set. The value of CaptureDate is represented as year-month-day, but instead, it may be represented in more detail such as yearmonth-day-hour-minute-second.

An example of the “valid data” described with reference to FIG. 28 in the event file 2800 is an information set 2901 that satisfies the following for a certain LinkID
The value of CaptureDate is equal to or newer than the value of LastDate described below included in EventDATA in the personal event table 224 of the onboard apparatus 2211.

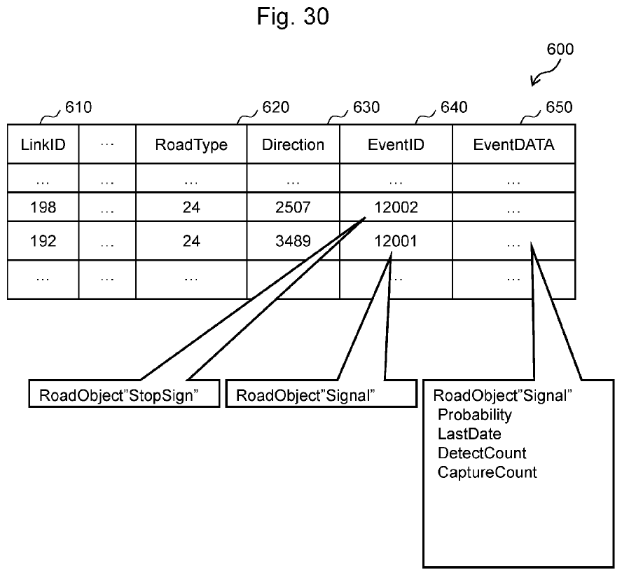

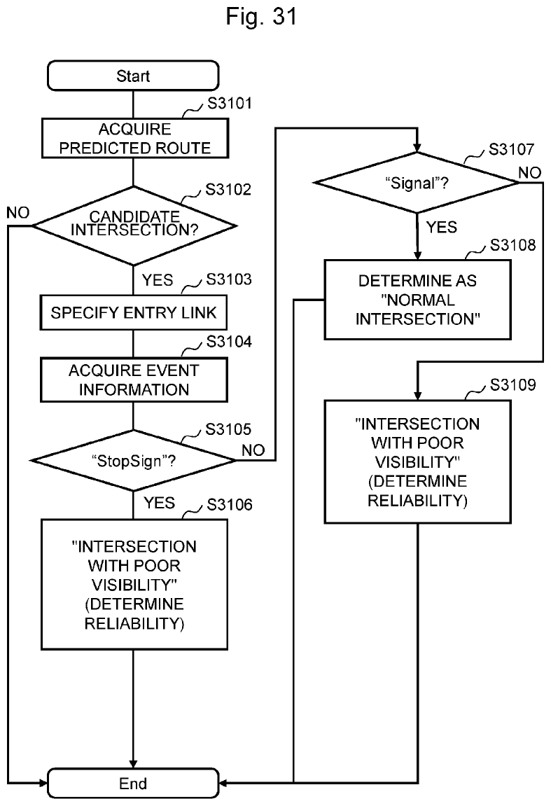

FIG. 30 is a diagram illustrating an example of the personal event table 600 in the management server apparatus 2220.

For the same user, the personal event table 600 in the management server apparatus 2220 is equal to as or newer than that in the personal event table 224 in the on-board apparatus 2211. In other words, the event file 2800 based on the personal event table 600 in the management server apparatus 2220 is reflected on the personal event table 224 in the on-board apparatus 2211 as appropriate, so that the personal event table 224 in the on-board apparatus 2211 is in the latest state.

In the personal event table 600, the EventID 640 depends on the type of the object detected as a result of the image recognition. For example, “12001” is allocated when the value of RoadObject is “Signal”. Further, for example, “12002” is allocated when the value of RoadObject is “StopSign”.

In the personal event table 600, information items for values (information) included in the EventDATA 650 include, for example, RoadObject, Probability, LastDate, DetectCount, and CaptureCount. Hereinafter, one LinkID will be taken as an example (“target LinkID” in the description of FIG. 30).

RoadObject is an information item in which a value indicating the type of the object detected for the target LinkID is set. The value of RoadObject is “StopSign” or “Signal”. Here, “StopSign” and “Signal” are as described with reference to FIG. 29. The value of RoadObject is set in the event file 2800 as the value of ObjectName.

Probability is an information item in which a value of Probability is set for the target LinkID. The value of Probability here is an average value of values of Probability obtained from return values (e.g., in particular, values of Probability equal to or larger than Th_{P} described above) from the object detection server apparatus 2230 for the target LinkID.

LastDate is an information item in which a value indicating the latest date of image capturing for the target LinkID is set. The value of LastDate is represented as yearmonth-day, but instead, it may be represented in more detail such as yearmonth-day-hour-minute-second. The value of LastDate is set in the event file 2800 as the value of CaptureDate.

DetectCount is an information item in which a value is set that indicates the total number of images in which objects of the type indicated by the value of RoadObject are detected for the target LinkID. The value of DetectCount is incremented by the information management unit 2403 when the value of Probability in a return value from the object detection server apparatus 2230 for the object is equal to or larger than Th_{P}.

CaptureCount is an information item in which a value indicating the total number of images captured for the target LinkID is set. The value of CaptureCount is incremented by the information management unit 2403 according to the number of images indicated by image data when the image data associated with the target LinkID is received from the on-board apparatus 2211 and the image data is saved.

At least one or some pieces in the personal event table 600 may be updated based on at least one or some pieces in the personal event table 600 for one or more other users. For example, for the target LinkID, statistics of the event information (EventID 640 and EventDATA 650) of all users may be acquired, and the statistics may be reflected on the event information of each user. In this case, even for an intersection with poor visibility for the first time for a certain user, the LinkID corresponding to the entry road is associated with event information based on event information for the other user, so that it can be expected that appropriate driving assistance is provided for the first intersection with poor visibility.

The event file 2800 illustrated in FIG. 29 is generated based on the personal event table 600 in the management server apparatus 2220 as described above, and the personal event table 224 in the on-board apparatus 2211 is updated to the latest state based on the event file 2800 (e.g., the value of DetectCount and the value of CaptureCount in the information set 2901 in the event file 2800 are added to the value of DetectCount and the value of CaptureCount in EventDATA corresponding to the LinkID in the information set 2901). As a result, in the on-board apparatus 2211, the event information including the recognition result information of the image captured for the entry link is associated with the LinkID of the entry link Based on the personal event table 224, the on-board apparatus 2211 performs intersection determination processing.

FIG. 31 illustrates an example of a flowchart related to the intersection determination processing.

In steps S3101 to S3104, the same processing as steps S2701 to S2704 illustrated in FIG. 27 is performed. The intersection determination processing may be performed periodically or aperiodically independently of (e.g., in parallel to) the processing illustrated in FIG. 27, or may be performed as part of the processing illustrated in FIG. 27. In the latter case, for example, steps S2701 to S2704 illustrated in FIG. 27 are performed, and if it is determined in step S2705 that the candidate is sufficiently recognized as the outside world, the processing of step S3105 and the subsequent steps may be performed.

In step S3105, the information management unit 2302 determines whether or not the entry link is associated with an object type of “StopSign” from the EventID or the value of RoadObject corresponding to the entry link.

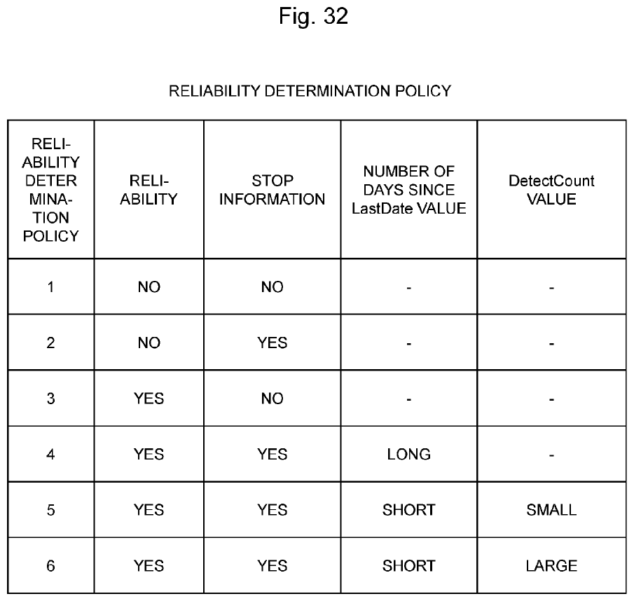

If the entry link is associated with an object type of “StopSign”, in step S3106, the information management unit 2302 determines the candidate intersection as an intersection with poor visibility and also determines the reliability. A reliability determination policy will be described below with reference to FIG. 32.

If the entry link is not associated with an object type of “StopSign”, in step S3107, the information management unit 2302 determines whether or not the entry link is associated with an object type of “Signal”.

If the entry link is associated with an object type of “Signal”, in step S3108, the information management unit 2302 determines the candidate intersection as a normal intersection.

If the entry link is not associated with an object type of “Signal”, in step S3109, the information management unit 2302 determines the candidate intersection as an intersection with poor visibility and also determines the reliability.

Information indicating whether the candidate intersection is an intersection with poor visibility or a normal intersection, and information indicating the reliability determined when the candidate intersection is determined to be an intersection with poor visibility may be saved in EventDATA (EventDATA corresponding to the entry link) in the personal event table 224. If the EventDATA includes information indicating that the candidate intersection is determined to be a normal intersection, or if the candidate intersection is determined to be an intersection with poor visibility and the determined reliability is equal to or larger than a predetermined value, the candidate intersection may be determined to be sufficiently recognized as the outside world in step S2705 in FIG. 27.

FIG. 32 illustrates an example of the reliability determination policy.

The “reliability” is a value provided for an intersection with poor visibility and means a likelihood of the intersection with poor visibility. Information indicating the reliability is transmitted by the information provision unit 2301 to one or more ADAS units. When receiving the information, the ADAS unit provides driving assistance for an intersection with poor visibility according to the reliability indicated by the information. What kind of driving assistance for what reliability and is performed may depend on the ADAS unit (e.g., when the reliability is equal to or larger than a certain numerical value, predetermined driving assistance may be provided). Further, for example, the information indicating the reliability may be transmitted immediately after the reliability is determined, or may be transmitted when the reliability is determined and the remaining distance is equal to or smaller than a predetermined distance. Further, the reliability may be represented as other kinds of codes such as alphabets instead of or in addition to the numbers.

In the example of FIG. 32, the higher the numerical value as the reliability, the higher the reliability. The reliability determination policy illustrated in FIG. 32 may be saved, for example, as information (e.g., a file) in the on-board apparatus 2211, or may be described in a program that is a base of the information management unit 2302 that is an example of a function for determining the reliability.

The determination factor for reliability includes, for example, at least one of the presence or absence of stop information, the presence or absence of recognition result information, the number of days elapsed from the value of LastDate, and the value of DetectCount. That is, the reliability depends on the amount of learning (e.g., the magnitude of the value of DetectCount) related to an intersection with poor visibility and the freshness of information (e.g., the number of days elapsed from the value of LastDate). For example, driving assistance may not be provided because the reliability has dropped smaller than a certain value, or driving assistance may be provided because the reliability has become equal to or larger than a certain value. The importance of the determination factor depends on the determination factor. An example of the importance of the determination factor is as follows.

That is, in the present embodiment, the importance of a determination factor of the presence or absence of recognition result information is the highest. If there is recognition result information (specifically, if there is an object type of “StopSign”), the reliability is high. If there is no recognition result information, the reliability is low.

The importance of a determination factor of the number of days elapsed from the value of LastDate is the second highest. In the case where there is recognition result information, if the number of days elapsed from the value of LastDate is short (e.g., if it is smaller than a certain value), the reliability is higher.

The importance of a determination factor of the value of DetectCount is the third highest. In the case where there is recognition result information and the number of days elapsed since the value of LastDate is short, if the value of DetectCount is large (e.g., if it is equal to or larger than a certain value), the reliability is much higher.

The importance of a determination factor of the presence or absence of stop information is the lowest. If there is no recognition result information and there is also no stop information, the reliability is lower. On the other hand, in the case where there is recognition result information, the number of days elapsed since the value of LastDate is short, and the value of DetectCount is large, if there is stop information, the reliability is higher.

The reliability of the candidate intersection being an intersection with poor visibility is determined, and driving assistance is provided according to the reliability following the reliability determination policy described above, so that it can be expected that appropriate driving assistance is provided for the candidate intersection.

Incidentally, in the present embodiment, image capturing is performed periodically or aperiodically from the start of image capturing to the end of image capturing as illustrated in FIG. 27. The installation position of a predetermined type of object such as a temporary stop object or a traffic light differs depending on the candidate intersection. Accordingly, in order to increase the certainty of capturing an image of the predetermined type of object for any candidate intersection, it is conceivable that a setting is made to start relatively early and end relatively late the image capturing period (the period from the start of image capturing to the end of image capturing). However, when such a setting is made, depending on the candidate intersection, the image capturing start timing may be too early or the image capturing end timing may be too late. Thus, the number of useless images becomes large, and as a result, the amount of data may be uselessly increased.

Therefore, in the present embodiment, image capturing timing adjustment processing is performed. Specifically, at least one of a threshold Th_{L} for the remaining distance L, which is an example of a parameter value affecting the image capturing start timing, and a, which is an example of a parameter value affecting the image capturing end timing (a coefficient of the reference azimuth difference used in the exit determination) is adjusted. The adjustment is based on at least one of DetectedStartTiming and DetectedEndTiming included in each information set 2901 in the event file 2800. DetectedStartTiming and DetectcdEndTiming are specified by the information management unit 2403 of the management server apparatus 2220 from the return values (return values from the object detection server apparatus 2230) for each image captured during the image capturing period.

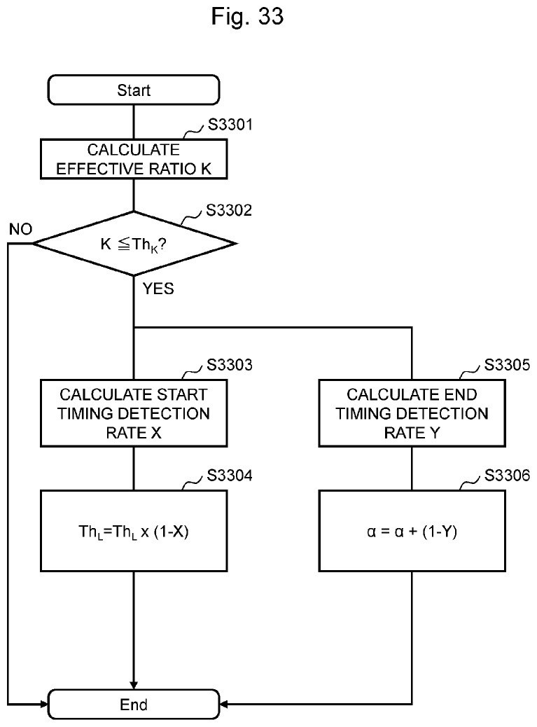

FIG. 33 illustrates an example of a flowchart related to processing including the image capturing timing adjustment processing. The processing is performed, for example, periodically or aperiodically (e.g., when the event file 2800 is acquired). The processing is performed, for example, for each candidate intersection (e.g., for each candidate intersection specified for the predicted route). In the description of FIG. 33, one candidate intersection is taken as an example (“target intersection” in the description of FIG. 33). Further, in the following description, an information set 2901-1 in FIG. 29 will be referred to as appropriate. In the description of FIG. 33, parameter values such as a value of DetectCount and a value of CaptureCount are values in the information set 2901-1. Further, the “image capturing timing adjustment processing” is a general term for image capturing start timing processing and image capturing end timing adjustment processing.

In step S3301, the information management unit 2302 calculates an effective ratio K for the target intersection. The “effective ratio” is a ratio of the number of images in which a predetermined type of object is detected to the total number of captured images, specifically, (the value of DetectCount)/(the value of CaptureCount). For example, according to the information set 2901-1, K=56/112=0.5 for LinkID “198”.

In step S3302, the information management unit 2302 determines whether or not the effective ratio K is equal to or smaller than a predetermined threshold Th_{K}. If the effective ratio is small, wasteful image capturing is increased, and therefore at least one of the image capturing start timing and the image capturing end timing is preferably adjusted. For example, if Th_{K}=0.6, K<=Th_{K} for LinkID “198”.

If K<=Th_{K}, at least one of the image capturing start timing adjustment processing including steps S3303 and S3304 and the image capturing end timing adjustment processing including steps S3305 and S3306 is performed.

The image capturing start timing adjustment processing is as follows.

That is, in step S3303, the information management unit 2302 calculates a start timing detection ratio X. The “start timing detection ratio” means that the number of captured images when the value of Probability reaches a value of 0.7 (a specific example of Th_{P} described above) or more from a value smaller than 0.7 in the image capturing period with respect to the number of images captured in the image capturing period, specifically, (the value of DetectedStartTiming)/(the value of CaptureCount). For LinkID “198”, X=40/112˜0.36. This means that about 36% of the images captured during the image capturing period are useless. Here, “A˜B” means B is nearly equal to A.

Therefore, in step S3304, the information management unit 2302 adjusts the threshold Th_{L} for the remaining distance L, which is an example of a parameter value affecting the image capturing start timing, based on the start timing detection ratio X. Specifically, the information management unit 2302 calculates Th_{L}=Th_{L}*(1−X). If Th_{L} before the adjustment is “30”, Th_{L} after the adjustment is 30*(1−0.36)=19.2 for LinkID “198”. As a result, the remaining distance L reaches Th_{L} later than before the adjustment, and accordingly, the start of image capturing is also delayed. As a result, it is possible to reduce wasteful image capturing. It is noted that Th_{L} of “19.2” after the adjustment is saved in EventDATA (EventDATA in the on-board apparatus 2211) corresponding to LinkID “198” by the information management unit 2302.

On the other hand, the image capturing end timing adjustment processing is as follows.

That is, in step S3305, the information management unit 2302 calculates an end timing detection ratio Y. The “end timing detection ratio” means that the number of captured images when the value of Probability reaches a value smaller than 0.7 (a specific example of Th_{P} described above) from a value of 0.7 or more in the image capturing period with respect to the number of images captured in the image capturing period, specifically, (the value of DetectedEndTiming)/(the value of CaptureCount). For LinkID “198”, X=100/112˜0.89. This means that 1−0.89=11% of the images captured during the image capturing period are useless.

Therefore, in step S3306, the information management unit 2302 adjusts a, which is an example of a parameter value affecting the image capturing end timing, based on the end timing detection ratio Y. Specifically, the information management unit 2302 calculates α=α+(1−Y). If a before the adjustment is “0.3”, a after the adjustment is 0.3+(1−0.89)=0.41. for LinkID “198”. As a result, |azimuth B−azimuth C|<=α×reference azimuth difference is satisfied earlier than before the adjustment, and accordingly, the end of image capturing is also earlier. As a result, it is possible to reduce wasteful image capturing. It is noted that a of “0.41” after the adjustment is saved in EventDATA (EventDATA in the on-board apparatus 2211) corresponding to LinkID “198” by the information management unit 2302.

As described above, at least one of the image capturing start timing and the image capturing end timing is optimized for each candidate intersection. This makes it possible to reduce wasteful image capturing, and as a result, it can be expected that the amount of data is reduced.

The foregoing is the description of the second embodiment. It is noted that, in the present embodiment, the start timing and the end timing of driving assistance for an intersection with poor visibility (a candidate intersection where a temporal stop object is detected, or a candidate intersection where neither a temporal stop object nor a predetermined type of traffic light is detected) may be the same as or different from the start timing and end timing of the image capturing for the candidate intersection.

### (3) Summary

It is noted that, in the above-described embodiments, a case is described in which the present invention is applied to the driving information providing system, but the present invention is not limited to this, and can be widely applied to various other systems, devices, methods, and programs.

In the above embodiments, the “vehicle” is typically an automobile.

In the above-described embodiments, the “storage apparatus” includes at least one of a memory and a persistent storage apparatus (typically, at least memory).

Further, in the above-described embodiments, the “memory” includes one or more memory devices, and may typically be a main storage apparatus. At least one memory device in the memory may include a volatile memory device, or may include a nonvolatile memory device.

Further, in the above-described embodiments, the “persistent storage apparatus” includes one or more permanent storage apparatuses. The persistent storage apparatus includes typically a nonvolatile storage apparatus (e.g., an auxiliary storage apparatus), specifically, for example, an HDD or an SSD.

In the above-described embodiments, the “control apparatus” includes a processor, specifically, one or more processor devices. At least one processor typically includes a microprocessor such as CPU, but may include a processor of another type such as GPU (Graphics Processing Unit). The at least one processor may include a single-core processor or a multi-core processor. The at least one processor may include a processor device in a broad sense, such as a hardware circuit (e.g., FPGA (Field-Programmable Gate Array) or ASIC (an Application Specific Integrated Circuit)) which performs a part or the whole of the processing.

Further, in the above-described embodiments, each table is exemplary. One table may be divided into two or more tables or all or any of two or more tables may be one table. Further, in the above-described embodiments, at least a part of the information may be information having any structure (e.g., may be structured data or unstructured data), or may be a learning model such as a neural network that generates an output with respect to an input.

Further, in the above-described embodiments, each function is described using an expression of “kkk unit”, but the function may be implemented by a control apparatus (processor) executing one or more computer programs, and may be implemented by one or more hardware circuits (e.g., FPGA or ASIC), or by a combination thereof. In a case where a function is implemented by the control apparatus executing one or more programs, the function may be at least a part of the control apparatus because defined processing is performed using a storage apparatus and/or a communication apparatus as appropriate. The processing described using the function as the subject may be processing performed by the control apparatus or an apparatus including the control apparatus. The program may be installed from a program source. The program source may be, for example, a program distribution computer or a recording medium (e.g., non-transitory recording medium) which is readable by the computer. The description of each function is an example, and a plurality of functions may be combined into one function, or one function may be divided into a plurality of functions.

Further, in the above description, information such as programs, tables, and files related to the functions can be stored in a storage apparatus such as a memory, a hard disk, or an SSD, or a recording medium such as an IC card, an SD card, or a DVD.

(3-1) Summary of First Embodiment

The first embodiment can be summarized as follows, for example.

A driving information providing system (e.g., the driving information providing system 100) includes a stop information acquisition unit (e.g., a stop information acquisition unit 407) that acquires stop information (e.g., a stop position and a stop azimuth) when the vehicle stops with respect to an intersection (e.g., an intersection with poor visibility) where a vehicle (e.g., the vehicle 110) enters a second road (e.g., a wide road) from a first road (e.g., a narrow road); and an information management unit (e.g., the information management unit 503) that stores the stop information acquired by the stop information acquisition unit in association with link information (e.g., which may be link information of the first road, link information of the second road, or link information of another road related to the intersection) of a road related to the intersection.

With the above configuration, since the stop information when the vehicle stops with respect to the intersection is stored in association with the link information, for example, providing the stop information, information on a distance to the intersection calculated from the stop information, and the like to an advanced driving assistance system (e.g., an ADAS unit) makes it possible to assist a driving operation related to the intersection and to avoid an accident related to the intersection. Further, for example, providing the stop information or the like to an output apparatus (e.g., the display apparatus 230, a speaker, or other output apparatus) makes it possible to alert the user and support comfortable driving, for example, by means of informing that the vehicle is required to stop, or by means of highlighting a stop line displayed on the NAVI screen.

It is noted that the timing at which the stop information and the like are provided to the advanced driving assistance system and the like may be, but not limited to, when the on-board apparatus detects an intersection by predicting a travel route, when the vehicle reaches at a predetermined distance from the intersection, or other timing.

The stop information acquisition unit determines whether or not the shape of a road from the position of the vehicle to the intersection is straight based on map information (e.g., map information 222) including information for specifying the type of the road. When determining that the shape is straight, the stop information acquisition unit acquires the stop information (see, for example, FIG. 10).

With this configuration, for example, it is possible to reduce the possibility that inappropriate stop information is acquired in a road environment where roads are dense in a residential area or the like. Further, for example, even when the road on which the vehicle is traveling cannot be specified because the map matching cannot be performed due to dense roads in a residential area or the like, it is possible to determine whether or not the road is the target for acquiring the stop information, thereby avoiding a situation where the stop information cannot be acquired.

When detecting that the first road is a narrow road and the second road is a wide road based on map information (e.g., map information 222) including information for specifying the type of the road, the stop information acquisition unit estimates that the intersection is an intersection with poor visibility, and acquires the stop information when the vehicle stops with respect to the intersection with poor visibility (see FIGS. 7, 8, and 10).

With this configuration, for example, it is possible to transmit the stop information and the like related to the intersection with poor visibility to the advanced driving assistance system or the like, so that driving assistance for the intersection with poor visibility can be provided.

In a case where one or more other pieces of stop information for the link information have been stored when the information management unit stores the stop information acquired by the stop information acquisition unit in association with the link information, the information management unit performs filtering processing on the stop information and the other stop information to remove noise to calculate a representative value, and stores the calculated representative value in association with the link information as stop information related to the intersection (see, for example, FIG. 11).

With this configuration, for example, excluding the stop information serving as noise when the vehicle temporarily stops to pass by another vehicle or temporarily stops to ensure pedestrian safely makes it possible to acquire more accurate stop information, so that driving assistance for the intersection can be provided at more appropriate timing.

The stop information includes position information indicating a position when the vehicle stops. Provided are a remaining distance calculation unit (e.g., the remaining distance calculation unit 408) that calculates a distance from the position of the vehicle to the position of the stop information, and an information provision unit (e.g., the information provision unit 411) that transmits information indicating the distance calculated by the remaining distance calculation unit to the advanced driving assistance system (e.g., an ADAS unit).

With this configuration, for example, providing the distance from the position of the vehicle to the position of the stop information to the advanced driving assistance system makes it possible to provide appropriate driving assistance related to the intersection, taking into account the position to stop with respect to the intersection, for example, by means of reducing the speed of the vehicle or by means of outputting a warning sound.

The remaining distance calculation unit calculates the distance each time the position of the vehicle is updated by dead reckoning (e.g., FIG. 13).

With this configuration, for example, it is possible to transmit a more accurate distance from the position of the vehicle to the position of the stop information to the advanced driving assistance system, so that driving assistance for the intersection can be provided at more appropriate timing.

A trajectory information acquisition unit (e.g., the trajectory information acquisition unit 409) that acquires, as trajectory information, the position of the vehicle after the vehicle stops with respect to the intersection is provided. The information management unit stores the trajectory information acquired by the trajectory information acquisition unit in association with link information of a road related to the intersection (see, for example, FIG. 16).

With this configuration, since the trajectory information related to the intersection is acquired, for example, providing the trajectory information to the advanced driving assistance system makes it possible to provide driving assistance for the intersection, for example, by means of controlling the speed of the vehicle when the vehicle is passing through the intersection. Further, displaying a travel route, a radius of curvature, and the like on the NAVI screen makes it possible to provide driving assistance for the intersection.

Provided are a leaving information acquisition unit (e.g., the leaving information acquisition unit 410) that determines whether or not the vehicle has left the intersection, and, when determining that the vehicle has left the intersection, acquires leaving information indicating that the vehicle has left the intersection, and an information provision unit (e.g., the information provision unit 411) that transmits the leaving information acquired by the leaving information acquisition unit to the advanced driving assistance system (e.g., an ADAS unit).

With this configuration, providing the leaving information indicating that the vehicle has left the intersection to the advanced driving assistance system makes it possible to end the driving assistance for the intersection provided by the advanced driving assistance system at appropriate timing.

The leaving information acquisition unit determines whether or not the vehicle has left the intersection based on an azimuth of the vehicle when the vehicle stops, an azimuth of a link of the second road, and the current azimuth of the vehicle.

With this configuration, for example, even when the entry road and the exit road are at an acute angle, it is possible to avoid a situation in which an erroneous determination is caused that the vehicle has left the intersection at the time when the vehicle stops at the position of a stop line.

(3-2) Summary of Second Embodiment

The second embodiment can be summarized as follows, for example.

The on-board apparatus 2211, which navigates the vehicle 110 based on the map information 222 including information indicating a road network including a plurality of links respectively corresponding to a plurality of roads and a plurality of nodes respectively corresponding to a plurality of intersections, and information indicating road attributes in the road network, includes the image capturing unit 2303 and the support control unit 2300. The image capturing unit 2303 captures an image of at least a part around the vehicle 110. The support control unit 2300 associates supplementary information, which is information including recognition result information indicating a result of image recognition of the captured image, with link information of a target link, which is a link corresponding to a point related to the image capturing of the image. The supplementary information may be event information including EventID and EventDATA, or instead of or in addition to the event information, information associated with the link information in the map information 222.

With this configuration, the image of at least a part around the vehicle 110 is captured. As a result, a road environment that cannot be specified from the map information 222 can be found from the result of image recognition of the captured image with respect to the point related to the image capturing. Associating the supplementary information including the recognition result information indicating the result of the image recognition with the link information of the target link corresponding to the point related to the image capturing makes it possible to improve appropriateness of driving assistance for the point based on the supplementary information. In other words, it is possible to reduce the possibility that driving assistance suitable for the road environment is not provided. It is possible to reduce the possibility that driving assistance suitable for the road environment at the point is preferably provided but the driving assistance is not provided, and the possibility that driving assistance is unnecessary but the driving assistance is provided.

The support control unit 2300 predicts a travel route of the vehicle 110 based on the individual information 280 including the travel history table 223 indicating the history of links corresponding to roads on which the vehicle 110 has traveled in the past. The navigation is performed using the vehicle position acquired by at least one of map matching and dead reckoning based on the map information 222. The target link is a link to which a point included in the predicted route (predicted travel route) and related to image capturing belongs, or a link corresponding to a road included in the predicted route and connected to the point and before the vehicle 110 enters the point. The link information of the target link is link information of at least one of the map information 222 and the individual information 280.

With this configuration, since the predicted route is provided, it is possible to predict that the vehicle 110 is in traveling on the target road even when map matching is not performed on the target road (the road corresponding to the target link). Accordingly, it is possible to associate the link information of the target link with the supplementary information including the information indicating the result of recognizing the image captured for the target road.

The support control unit 2300 determines from the map information 222 whether or not there is a candidate point, which is a candidate for the corresponding point, on the predicted route. When it is determined that there is a candidate point and that the vehicle 110 is close to the candidate point, the image capturing unit 2303 captures an image of at least a part around the vehicle 110.

With this configuration, it is possible to specify a candidate point based on the predicted route and the map information 222 and capture an image for the specified candidate point without an instruction from the user.

When it is determined that there is a candidate intersection, the support control unit 2300 periodically or aperiodically calculates the remaining distance L, which is a distance (e.g., approximate remaining distance or exact remaining distance) from a recently acquired vehicle position to a reference point according to the candidate point. When the remaining distance L is smaller than the predetermined distance Th_{L}, image capturing is performed.

With this configuration, it is possible to start image capturing at an appropriate timing.

It is noted that the candidate point is a candidate intersection that is a candidate for an intersection connecting a narrow road to a wide road and also an intersection with poor visibility, and the reference point according to the candidate point is either the candidate intersection or a stop position that is a position at which the vehicle stops on a narrow road before entering the candidate intersection. When there is stop information indicating the stop position, the remaining distance L is a distance from a recently acquired vehicle position to the stop position (e.g., exact remaining distance).

With this configuration, the accuracy of the calculated remaining distance L is improved.

Further, when the shape of a road from the recently acquired vehicle position on the narrow road to the candidate intersection is straight, the support control unit 2300 acquires stop information indicating a stop position that is a position at which the vehicle stops on the narrow road before entering the candidate intersection.

With this configuration, it is possible to reduce the possibility that inappropriate stop information is acquired with respect to a road environment in which appropriate stop information cannot always be acquired for all target intersections because the target intersections are dense.

The supplementary information includes, in addition to the recognition result information, stop information when the stop information is acquired. The vehicle 110 includes one or more ADAS units that, when receiving information indicating a reliability, operate according to the reliability. The support control unit 2300 determines the reliability of the candidate intersection being an intersection with poor visibility based on the supplementary information associated with the link information of the link corresponding to the narrow road, and transmits information indicating the reliability to at least one of the one or more ADAS units.

With this configuration, it is expected that the reliability indicated by the information to be transmitted to the ADAS unit is high, and thus appropriate driving assistance is expected. It is noted that this also applies to a case in which stop information is not acquired. This is because the reliability is determined based on other information elements of the supplementary information.

The support control unit 2300 determines whether or not the point related to the image capturing is the corresponding point depending on whether or not the recognition result information includes information indicating that a predetermined type of object appears in the image.

With this configuration, since the road environment of the point related to the image capturing is determined from the type of the object appears in the image, it can be expected that the accuracy of the determination is high and thus appropriate driving assistance is provided.

When the point is a candidate intersection and the recognition result information includes information indicating that a temporary stop object appears in the image, the support control unit 2300 determines that the candidate intersection is an intersection with poor visibility.

With this configuration, it is possible to increase the possibility that the candidate intersection is an intersection with poor visibility.

When the recognition result information includes information indicating that a temporary stop object does not appear in the image and a predetermined type of traffic light does not also appear, the support control unit 2300 determines that the candidate intersection is an intersection with poor visibility.

With this configuration, the possibility that the candidate intersection is an intersection with poor visibility is not high as compared with the case where a temporary stop object appears in the image, but the predetermined type of traffic light does not appear, so that there is a possible that driving assistance for an intersection with poor visibility is preferable for the candidate intersection. It is determined that such an intersection is also an intersection with poor visibility.

When the recognition result information includes information indicating that a predetermined type of traffic light appears in the image, the support control unit 2300 determines that the candidate intersection is a normal intersection. When it is determined that the candidate intersection is a normal intersection, the support control unit 2300 does not transmit information related to an intersection with poor visibility for the candidate intersection to the one or more ADAS units.

With this configuration, it is possible to prevent driving assistance for an intersection with poor visibility from being provided even for an intersection where driving is performed according to a predetermined type of traffic light.

After a predetermined type of parameter value (e.g., remaining distance L) related to the vehicle 110 has reached a threshold (e.g., Th_{L}) that is defined as the vehicle 110 being close to an example of a point (e.g., candidate intersection) related to image capturing, the image capturing unit 2303 performs image capturing periodically or aperiodically in accordance with one or more instructions from the support control unit 2300. For each captured image, return values (an example of information indicating a result of image recognition of the image) include information indicating a result of determining whether or not a predetermined type of object (e.g., a temporary stop object or a predetermined type of traffic light) appears in the image, and information indicating a possibility that the determination is correct (e.g., a value of Probability). The support control unit 2300 executes image capturing start timing adjustment processing. The image capturing start timing adjustment processing is processing of changing, based on the number of images (e.g., a value of CaptureCount) captured from the start of image capturing to the end of image capturing at the point, and the number of captured images (e.g., a value of DetectedStartTiming) when a probability (e.g., a value of Probability) that a predetermined type of object appears in the image after the start of image capturing at the point reaches a value equal to or larger than a predetermined ratio (e.g., Th_{P}) n times or more (n is a natural number), the threshold (e.g., Th_{L}) to a value such that the predetermined type of parameter value reaches it more later (e.g., reducing Th_{L}).

With this configuration, the image capturing start timing can be appropriately delayed based on the ratio of images that are considered to be useless from among the images captured from the start of image capturing to the end of image capturing.

It is noted that the support control unit 2300 executes the image capturing start timing adjustment processing when a value (e.g., effective ratio K) obtained based on the number of images (e.g., a value of CaptureCount) captured from the start of image capturing to the end of image capturing at the point, and the number of images (e.g., a value of DetectCount) in which it is determined that a predetermined type of object appears at the point is equal to or smaller than a predetermined value (e.g., Th_{K}).

With this configuration, when the ratio of valid images (images in which a predetermined type of object is detected) from among the images captured during the image capturing period is small, in other words, when there are many useless images, the image capturing start timing adjustment processing is performed. Therefore, the execution frequency of the image capturing start timing adjustment processing can be made appropriate.

Until a predetermined type of parameter value (e.g., |azimuth B−azimuth C|) related to the vehicle 110 reaches a threshold (e.g., α×reference azimuth difference) that is defined as the vehicle 110 having left, the image capturing unit 2303 performs image capturing periodically or aperiodically in accordance with one or more instructions from the support control unit 2300. The support control unit 2300 executes image capturing end timing adjustment processing. The image capturing end timing adjustment processing is processing of changing, based on the number of images (e.g., a value of CaptureCount) captured from the start of image capturing to the end of image capturing at the point, and the number of captured images (e.g., a value of DetectedEndTiming) when a probability (e.g., a value of Probability) that a predetermined type of object appears in the image after the start of image capturing at the point reaches a value smaller than a predetermined ratio (e.g., Th_{P}) from a value equal to or larger than the predetermined ratio m times or more (m is a natural number), the threshold (e.g., Th_{L}) to a value such that the predetermined type of parameter value reaches it more earlier (e.g., increasing α).

With this configuration, the image capturing end timing can be appropriately early based on the ratio of images that are considered to be useless from among the images captured from the start of image capturing to the end of image capturing.

It is noted that the support control unit 2300 executes the image capturing end timing adjustment processing when a value (e.g., effective ratio K) obtained based on the number of images (e.g., a value of CaptureCount) captured from the start of image capturing to the end of image capturing at the point, and the number of images (e.g., a value of DetectCount) in which it is determined that a predetermined type of object appears at the point is equal to or smaller than a predetermined value (e.g., Th_{K}).

With this configuration, when the ratio of valid images (images in which a predetermined type of object is detected) from among the images captured during the image capturing period is small, in other words, when there are many useless images, the image capturing end timing adjustment processing is performed. Therefore, the execution frequency of the image capturing end timing adjustment processing can be made appropriate.

The support control unit 2300 stops the image capturing performed by the image capturing unit 2303 while it is determined that the vehicle 110 stops during the image capturing period.

With this configuration, since there is no change in the image even if the image capturing is repeated during the stop, it is possible to avoid wasteful image capturing.

When image recognition is performed on an image captured by an image capturing unit of a vehicle different from the vehicle 110 for the target link, recognition result information indicating a result of image recognition of the image captured by the image capturing unit of the other vehicle may be reflected on the supplementary information associated with the link information of the target link.

With this configuration, even for a point for the first time for a certain user, the link information of the target link is associated with supplementary information based on supplementary information for the other user, so that it can be expected that appropriate driving assistance is provided for the first point.

Any part of the functions of the on-board apparatus 2211 may be provided in the management server apparatus 2220, at least one or some of the functions of the management server apparatus 2220 may be provided in the on-board apparatus 2211, or at least one or some of the functions of the object detection server apparatus 2230 may be provided in the on-board apparatus 2211. For example, instead of the on-board apparatus 2211 storing at least one of the travel history table 223 and the personal event table 224, the management server apparatus 2220 may store at least one of the travel history table and the personal event table. Further, instead of the on-board apparatus 2211, the management server apparatus 2220 may perform various processing (e.g., at least one of the processing of specifying a candidate intersection from the map information 222, the processing illustrated in FIG. 31, and the processing illustrated in FIG. 33). The driving assistance system 2200 may be configured from the on-board apparatus 2211 and/or the management server apparatus 2220 from among the on-board apparatus 2211, the management server apparatus 2220, and the object detection server apparatus 2230. For example, the driving assistance system 2200 includes an image acquisition unit that acquires image data indicating a captured image of at least a part around the vehicle 110, and the support control unit 2300 that associates supplementary information, which is information including recognition result information indicating the result of image recognition of the captured image, with the link information of the target link, which is a link corresponding to a point related to the image capturing of the image. The image acquisition unit may be at least one of the image capturing unit 2303 and the information management unit 2403 that receives and saves image data from the on-board apparatus 2211.

Further, the above-described configurations may be changed, rearranged, combined, or omitted as appropriate without departing from the scope of the present invention. Furthermore, in both the first embodiment and the second embodiment, whether or not the intersection where the vehicle enters the second road from the first road is an “intersection with poor visibility” does not depend on whether or not the visibility is poor due to meteorological phenomenon such as weather, but depends on whether or not the first road is a narrow road and the second road is a wide road (e.g., whether or not it is relatively likely that a part of the user's view is blocked by roadside objects such as buildings or block walls). For this reason, an “intersection with poor visibility” may be described, for example, as an “intersection with a poor visibility of the side streets by roadside objects.

### REFERENCE SIGNS LIST

2200 Driving assistance system
2210 Vehicle
2211 On-board apparatus

1. An on-board apparatus that performs navigation for a vehicle based on map information including information indicating a road network including a plurality of links respectively corresponding to a plurality of roads and a plurality of nodes respectively corresponding to a plurality of intersections and information indicating road attributes in the road network, the on-board apparatus comprising:
an image capturing unit that captures an image of at least a part around the vehicle; and
a support control unit that associates supplementary information that is information including recognition result information indicating a result of image recognition of the captured image with link information of a target link that is a link corresponding to a point related to the image capturing of the image.

2. The on-board apparatus according to claim 1, wherein
the support control unit predicts a travel route of the vehicle based on individual information including a history of links corresponding to roads on which the vehicle has traveled in the past,
the navigation is performed using a vehicle position acquired by at least one of map matching and dead reckoning based on the map information,
the target link is a link to which a point included in a predicted route that is the predicted travel route and that is related to the image capturing of the image belongs, or a link corresponding to a road included in the predicted route and connected to the point and before the vehicle enters the point, and
the link information of the target link is link information of at least one of the map information and the individual information.

3. The on-board apparatus according to claim 2, wherein
the support control unit determines from the map information whether there is a candidate point that is a candidate for the corresponding point on the predicted route,
the image capturing unit captures, when it is determined that there is the candidate point and that the vehicle is close to the candidate point, an image of at least a part around the vehicle, and
the candidate point is a point related the image capturing of the image.

4. The on-board apparatus according to claim 3, wherein
the support control unit periodically or aperiodically calculates, when it is determined that there is the candidate point, a remaining distance that is a distance from a recently acquired vehicle position to a reference point according to the candidate point, and
when it is determined that the vehicle is close to the candidate point is when the remaining distance is smaller than a predetermined distance.

5. The on-board apparatus according to claim 4, wherein
the candidate point is a candidate intersection that is a candidate for an intersection connecting a narrow road to a wide road and also an intersection with poor visibility,
the reference point according to the candidate point is one of the candidate intersection and a stop position that is a position at which the vehicle stops on the narrow road before entering the candidate intersection, and
when there is stop information indicating the stop position, the remaining distance is a distance from a recently acquired vehicle position to the stop position.

6. The on-board apparatus according to claim 5, wherein the support control unit acquires, when a shape of a road from the recently acquired vehicle position on the narrow road to the candidate intersection is straight, stop information indicating a stop position that is a position at which the vehicle stops on the narrow road before entering the candidate intersection.

7. The on-board apparatus according to claim 5, wherein
the supplementary information includes, in addition to the recognition result information, the stop information when the stop information is acquired,
the vehicle includes one or more ADAS (Advanced Driver Assistance System) units that operate according to a reliability when information indicating the reliability is received, and
the support control unit determines a reliability of the candidate intersection being an intersection with poor visibility based on the supplementary information associated with link information of a link corresponding to the narrow road, and transmits information indicating the reliability to at least one of the one or more ADAS units.

8. The on-board apparatus according to claim 1, wherein the support control unit determines whether the point related to the image capturing of the image is a corresponding point depending on whether the recognition result information includes information indicating that a predetermined type of object appears in the image.

9. The on-board apparatus according to claim 8, wherein
the point is a candidate intersection that is a candidate for an intersection connecting a narrow road to a wide road and also an intersection with poor visibility, and
the support control unit determines, when the recognition result information includes information indicating that a temporary stop object that is an object representing temporal stop appears in the image, that the candidate intersection is an intersection with poor visibility.

10. The on-board apparatus according to claim 9, wherein
the support control unit determines, when the recognition result information includes information indicating that a temporary stop object does not appear in the image and a predetermined type of traffic light does not also appear, that the candidate intersection is an intersection with poor visibility.

11. The on-board apparatus according to claim 9, wherein
the support control unit determines, when the recognition result information includes information indicating that a predetermined type of traffic light appears in the image, that the candidate intersection is a normal intersection, and
the support control unit does not transmit, when it is determined that the candidate intersection is a normal intersection, information related to an intersection with poor visibility for the candidate intersection to the one or more ADAS units of the vehicle.

12. The on-board apparatus according to claim 1, wherein
the image capturing unit performs, when or after a predetermined type of parameter value related to the vehicle has reached a threshold that is defined as the vehicle being close to the point, image capturing periodically or aperiodically in accordance with one or more instructions from the support control unit,
for each captured image, information indicating a result of image recognition of the image includes information indicating a result of determining whether a predetermined type of object appears in the image and information indicating a probability of the determination being correct,
the support control unit executes image capturing start timing adjustment processing, and
the image capturing start timing adjustment processing is processing of changing, based on the number of images captured from a start of image capturing to an end of image capturing at the point, and the number of captured images when a probability of a predetermined type of object appearing in the image after the start of image capturing at the point reaches a value equal to or larger than a predetermined ratio n times or more (n is a natural number), the threshold to a value such that the predetermined type of parameter value reaches the value more later.

13. The on-board apparatus according to claim 12, wherein the support control unit executes the image capturing start timing adjustment processing when a value obtained based on the number of images captured from the start of image capturing to the end of image capturing at the point and the number of images in which it is determined that the predetermined type of object appears is equal to or smaller than a predetermined value.

14. The on-board apparatus according to claim 1, wherein
the image capturing unit performs, until a predetermined type of parameter value related to the vehicle reaches a threshold that is defined as the vehicle having left, image capturing periodically or aperiodically in accordance with one or more instructions from the support control unit,
for each captured image, information indicating a result of image recognition of the image includes information indicating a result of determining whether a predetermined type of object appears in the image and information indicating a probability of the determination being correct,
the support control unit executes image capturing end timing adjustment processing,
the image capturing end timing adjustment processing is processing of changing, based on the number of images captured from a start of image capturing to an end of image capturing at the point, and the number of captured images when a probability of a predetermined type of object appearing in the image after the start of image capturing at the point reaches a value smaller than a predetermined ratio from a value equal to or larger than the predetermined ratio m times or more (m is a natural number), the threshold to a value such that the predetermined type of parameter value reaches the value more earlier.

15. The on-board apparatus according to claim 14, wherein the support control unit executes the image capturing end timing adjustment processing when a value obtained based on the number of images captured from the start of image capturing to the end of image capturing at the point and the number of images in which it is determined that the predetermined type of object appears is equal to or smaller than a predetermined value.

16. The on-board apparatus according to claim 1, wherein
the image capturing unit performs, when the vehicle is close to the point, image capturing periodically or aperiodically in accordance with one or more instructions from the support control unit, and
the support control unit causes the image capturing unit to stop the image capturing while it is determined that the vehicle stops in a period in which image capturing is performed periodically or aperiodically.

17. The on-board apparatus according to claim 1, wherein
the vehicle includes one or more ADAS (Advanced Driver Assistance System) units that operate according to a reliability when information indicating the reliability is received, and
the support control unit determines a reliability of the point being the corresponding point based on the supplementary information associated with link information of the target link, and transmits information indicating the reliability to at least one of the one or more ADAS units.

18. The on-board apparatus according to claim 1, wherein, when image recognition is performed on an image captured by an image capturing unit of a vehicle different from the vehicle for the target link, recognition result information indicating a result of image recognition of the image captured by the image capturing unit of the other vehicle is reflected on the supplementary information associated with the link information of the target link.

19. A driving assistance method for a vehicle to be navigated based on map information including information indicating a road network including a plurality of links respectively corresponding to a plurality of roads and a plurality of nodes respectively corresponding to a plurality of intersections and information indicating road attributes in the road network, the driving assistance method comprising:
capturing an image of at least a part around the vehicle; and
associating supplementary information that is information including recognition result information indicating a result of image recognition of the captured image with link information of a target link that is a link corresponding to a point related to the image capturing of the image.

20. A driving assistance system for a vehicle to be navigated based on map information including information indicating a road network including a plurality of links respectively corresponding to a plurality of roads and a plurality of nodes respectively corresponding to a plurality of intersections and information indicating road attributes in the road network, the driving assistance system comprising:
an image capturing unit that captures an image of at least a part around the vehicle; and
a support control unit that associates supplementary information that is information including recognition result information indicating a result of image recognition of the captured image with link information of a target link that is a link corresponding to a point related to the image capturing of the image.
